(19) United States
(12) Patent Application Publication
(10) Pub. No.: US 2026/0003241 A1
(43) Pub. Date: Jan. 1, 2026

(54) VARIABLE LIGHT TRANSMISSION DEVICE COMPRISING MICROCELLS

(71) Applicant: E INK CORPORATION, Billerica, MA (US)

(72) Inventors: Bryan DUNN, Medford, MA (US); Yu XIA, Acton, MA (US); George G. HARRIS, Woburn, MA (US)

(21) Appl. No.: 19/244,578

(22) Filed: Jun. 20, 2025

Related U.S. Application Data
(60) Provisional application No. 63/664,300, filed on Jun. 26, 2024.

(51) Int. Cl. G02F 1/16757; G02F 1/167; G02F 1/1676

(52) U.S. Cl. CPC G02F 1/16757; G02F 1/167; G02F 1/1676

(57) ABSTRACT

A variable light transmission device is disclosed that mitigates negative aperture diffraction effects and shows good switching speed between the open and the closed optical states. The device comprises a microcell layer disposed between two light transmissive electrode layers, the microcell layer having a plurality of microcells, each microcell including an electrophoretic medium, each microcell comprising a protrusion structure, the protrusion structure having one or more wells.

### RELATED APPLICATION

This application claims priority to U.S. Provisional Patent Application No. 63/664,300 filed on Jun. 26, 2024, which is incorporated by reference in its entirety, along with all other patents and patent applications disclosed herein.

### BACKGROUND OF THE INVENTION

This invention relates to a variable light transmission device. Specifically, the invention relates to a microcell electro-optic device comprising an electrophoretic medium comprising electrically charged pigment particles and a non-polar liquid. The electrophoretic medium can switch between optical states using electric fields. The variable light transmission device can modulate the amount of light and other electromagnetic radiation passing through them. It can be used on mirrors, windows, sunroofs, and similar items. For example, the present invention may be applied on windows that can modulate light that enters buildings and vehicles. Examples of electrophoretic media that may be incorporated into various embodiments of the present invention include, for example, the electrophoretic media described in U.S. Pat. Nos. 7,116,466, 7,327,511, 8,576,476, 10,319,314, 10,809,590, 10,067,398, 10,067,398, and 11,143,930, and U.S. Patent Application Publication Nos. 2014/0055841, 2017/0351155, 2017/0235206, 2011/0199671, 2020/0355979, 2020/0272017, 2021/0096439, and U.S. patent application Ser. No. 17/953,386, filed on Sep. 27, 2022, the contents of which are incorporated by reference herein in their entireties.

Particle-based electrophoretic displays, in which a plurality of electrically charged pigment particles move through a suspending fluid under the influence of an electric field, have been the subject of intense research and development for a number of years. Such displays can have attributes of good brightness and contrast, wide viewing angles, state bistability, and low power consumption when compared with liquid crystal displays.

The terms “bistable” and “bistability” are used herein in their conventional meaning in the art to refer to displays comprising display elements having first and second display states differing in at least one optical property, and such that after any given element has been driven by means of an addressing pulse of finite duration, to assume either its first or second display state, after the addressing pulse has terminated, that state will persist for at least several times, for example at least four times, the minimum duration of the addressing pulse required to change the state of the display element. It is shown in published U.S. Patent Application Ser. No. 2002/0180687 that some particle-based electrophoretic displays capable of gray scale are stable not only in their extreme black and white states but also in their intermediate gray states, and the same is true of some other types of electro-optic displays. This type of display is properly called “multi-stable” rather than bistable, although for convenience the term “bistable” may be used herein to cover both bistable and multi-stable displays.

As noted above, electrophoretic media require the presence of a suspending fluid. In most prior art electrophoretic media, this suspending fluid is a liquid, but electrophoretic media can be produced using gaseous suspending fluids. Such gas-based electrophoretic media appear to be susceptible to the same types of problems due to particle settling as liquid-based electrophoretic media, when the media are used in an orientation which permits such settling, for example in a sign where the medium is disposed in a vertical plane. Indeed, particle settling appears to be a more serious problem in gas-based electrophoretic media than in liquid-based ones, since the lower viscosity of gaseous suspending fluids as compared with liquid ones allows more rapid settling of the electrically charged pigment particles.

Numerous patents and applications assigned to or in the names of the Massachusetts Institute of Technology (MIT), E Ink Corporation, E Ink California, LLC, and related companies describe various technologies used in encapsulated and microcell electrophoretic and other electro-optic media. Encapsulated electrophoretic media comprise numerous small capsules, each of which comprises an internal phase containing electrophoretically-mobile particles in a liquid medium, and a capsule wall surrounding the internal phase. Typically, the capsules are themselves held within a polymeric binder to form a coherent layer positioned between two electrodes. In a microcell electrophoretic display, the electrically charged pigment particles and the liquid are not encapsulated within microcapsules but instead are retained within a plurality of cavities formed within a carrier medium, typically a polymeric film. The technologies described in these patents and applications include:
(a) Electrophoretic particles, fluids and fluid additives; see for example U.S. Pat. Nos. 5,961,804; 6,017,584; 6,120,588; 6,120,839; 6,262,706; 6,262,833; 6,300,932; 6,323,989; 6,377,387; 6,515,649; 6,538,801; 6,580,545; 6,652,075; 6,693,620; 6,721,083; 6,727,881; 6,822,782; 6,831,771; 6,870,661; 6,927,892; 6,956,690; 6,958,849; 7,002,728; 7,038,655; 7,052,766; 7,110,162; 7,113,323; 7,141,688; 7,142,351; 7,170,670; 7,226,550; 7,230,750; 7,230,751; 7,236,290; 7,277,218; 7,286,279; 7,312,916; 7,382,514; 7,390,901; 7,473,782; 7,561,324; 7,583,251; 7,572,394; 7,576,904; 7,580,180; 7,679,814; 7,848,006; 7,903,319; 8,018,640; 8,115,729; 8,257,614; 8,270,064; 8,363,306; 8,390,918; 8,582,196; 8,654,436; 8,902,491; 8,961,831; 9,052,564; 9,341,915; 9,348,193; 9,361,836; 9,366,935; 9,372,380; 9,382,427; 9,423,666; 9,428,649; 9,557,623; 9,670,367; 9,671,667; 9,688,859; 9,726,957; 9,752,034; 9,765,015; 9,778,535; 9,778,537; 9,835,926; 9,953,588; 9,995,987; 10,025,157; 10,031,394; 10,040,954; 10,061,123; 10,062,337; 10,147,366; and 10,514,583; and U.S. Patent Application Publication Nos. 2003/0048522; 2003/0151029; 2003/0164480; 2004/0030125; 2004/0105036; 2005/0012980; 2009/0009852; 2011/0217639; 2012/0049125; 2013/0161565; 2013/0193385; 2013/0244149; 2013/0063333; 2014/0011913; 2014/0078576; 2014/0104674; 2014/0231728; 2015/0177590; 2015/0185509; 2015/0241754; 2015/0301425; and 2016/0170106;
(b) Capsules, binders and encapsulation processes; see for example U.S. Pat. Nos. 5,930,026; 6,067,185; 6,130,774; 6,262,706; 6,327,072; 6,392,786; 6,459,418; 6,727,881, 6,839,158; 6,866,760; 6,922,276; 6,958,848; 6,987,603; 7,110,164; 7,148,128; 7,184,197; 7,304,634; 7,327,511, 7,339,715; 7,411,719; 7,477,444; 7,561,324; 7,910,175; 7,952,790; 8,129,655; 8,446,664; and U.S. Patent Applications Publication Nos. 2005/0156340; 2007/0091417; and 2009/0122389;
(c) Microcell structures, wall materials, and methods of forming microcells; see for example U.S. Pat. Nos. 6,672,921; 6,751,007; 6,753,067; 6,781,745; 6,788,452; 6,795,229; 6,806,995; 6,829,078; 6,850,355; 6,865,012; 6,870,662; 6,885,495; 6,930,818; 6,933,098; 6,947,202; 7,046,228; 7,072,095; 7,079,303; 7,141,279; 7,156,945; 7,205,355; 7,233,429; 7,261,920; 7,271,947; 7,304,780; 7,307,778; 7,327,346; 7,347,957; 7,470,386; 7,504,050; 7,580,180; 7,715,087; 7,767,126; 7,880,958; 8,002,948; 8,154,790; 8,169,690; 8,441,432; 8,891,156; 9,279,906; 9,291,872; 9,388,307; 9,436,057; 9,436,058; 9,470,917; 9,919,553; and 10,401,668; and U.S. Patent Applications Publication Nos. 2003/0203101; 2014/0050814; and 2016/0059442;
(d) Methods for filling and sealing microcells; see for example U.S. Pat. Nos. 6,545,797; 6,788,449; 6,831,770; 6,833,943; 6,930,818; 7,046,228; 7,052,571; 7,166,182; 7,347,957; 7,374,634; 7,385,751; 7,408,696; 7,557,981; 7,560,004; 7,564,614; 7,572,491; 7,616,374; 7,715,087; 7,715,088; 8,361,356; 8,625,188; 8,830,561; 9,346,987; and 9,759,978; and U.S. Patent Applications Publication Nos. 2002/0188053; 2004/0120024; 2004/0219306; and 2015/0098124;
(e) Films and sub-assemblies containing electro-optic materials; see for example U.S. Pat. Nos. 6,825,829; 6,982,178; 7,110,164; 7,158,282; 7,554,712; 7,561,324; 7,649,666; 7,728,811; 7,826,129; 7,839,564; 7,843,621; 7,843,624; 7,952,790; 8,034,209; 8,177,942; 8,390,301; 9,238,340; 9,470,950; 9,835,925; and U.S. Patent Applications Publication Nos. 2005/0122563; 2007/0237962; and 2011/0164301;
(f) Backplanes, adhesive layers and other auxiliary layers and methods used in displays; see for example U.S. Pat. Nos. D485,294; 5,930,026; 6,120,588; 6,124,851; 6,177,921; 6,232,950; 6,252,564; 6,312,304; 6,312,971; 6,376,828; 6,392,786; 6,413,790; 6,480,182; 6,498,114; 6,506,438; 6,518,949; 6,545,291; 6,639,578; 6,657,772; 6,664,944; 6,683,333; 6,710,540; 6,724,519; 6,816,147; 6,819,471; 6,825,068; 6,831,769; 6,842,279; 6,842,657; 6,865,010; 6,873,452; 6,909,532; 6,967,640; 7,012,600; 7,012,735; 7,030,412; 7,075,703; 7,106,296; 7,110,163; 7,116,318; 7,148,128; 7,167,155; 7,173,752; 7,176,880; 7,190,008; 7,206,119; 7,223,672; 7,230,751; 7,256,766; 7,259,744; 7,301,693; 7,304,780; 7,327,346; 7,327,511; 7,347,957; 7,365,733; 7,388,572; 7,401,758; 7,492,497; 7,535,624; 7,551,346; 7,554,712; 7,560,004; 7,583,427; 7,649,674; 7,667,886; 7,672,040; 7,688,497; 7,826,129; 7,830,592; 7,839,564; 7,880,958; 7,893,435; 7,905,977; 7,952,790; 7,986,450; 8,034,209; 8,049,947; 8,072,675; 8,120,836; 8,159,636; 8,177,942; 8,237,892; 8,362,488; 8,395,836; 8,437,069; 8,441,414; 8,456,589; 8,514,168; 8,547,628; 8,576,162; 8,610,988; 8,714,780; 8,743,077; 8,754,859; 8,797,258; 8,797,633; 8,797,636; 9,147,364; 9,025,234; 9,025,238; 9,030,374; 9,140,952; 9,201,279; 9,223,164; 9,238,340; 9,285,648; 9,454,057; 9,529,240; 9,620,066; 9,632,373; 9,666,142; 9,671,635; 9,715,155; 9,777,201; 9,897,891; 10,037,735; 10,190,743; 10,324,577; 10,365,533; 10,372,008; 10,446,585; 10,466,565; 10,495,941; 10,503,041; 10,509,294; 10,613,407; and U.S. Patent Applications Publication Nos. 2002/0060321; 2004/0085619; 2004/0105036; 2005/0122306; 2005/0122563; 2006/0255322; 2009/0122389; 2010/0177396; 2011/0164301; 2011/0292319; 2014/0192000; 2014/0210701; 2014/0368753; and 2016/0077375; and International Application Publication Nos. WO2000/038000; WO2000/005704; and WO1999/067678;
(g) Color formation and color adjustment; see for example U.S. Pat. Nos. 6,017,584; 6,545,797; 6,664,944; 6,788,452; 6,864,875; 6,914,714; 6,972,893; 7,038,656; 7,038,670; 7,046,228; 7,052,571; 7,075,502; 7,167,155; 7,385,751; 7,492,505; 7,667,684; 7,684,108; 7,791,789; 7,800,813; 7,821,702; 7,839,564; 7,910,175; 7,952,790; 7,956,841; 7,982,941; 8,040,594; 8,054,526; 8,098,418; 8,159,636; 8,213,076; 8,363,299; 8,422,116; 8,441,714; 8,441,716; 8,466,852; 8,503,063; 8,576,470; 8,576,475; 8,593,721; 8,605,354; 8,649,084; 8,670,174; 8,704,756; 8,717,664; 8,786,935; 8,797,634; 8,810,899; 8,830,559; 8,873,129; 8,902,153; 8,902,491; 8,917,439; 8,964,282; 9,013,783; 9,116,412; 9,146,439; 9,164,207; 9,170,467; 9,170,468; 9,182,646; 9,195,111; 9,199,441; 9,268,191; 9,285,649; 9,293,511; 9,341,916; 9,360,733; 9,361,836; 9,383,623; and 9,423,666; and U.S. Patent Applications Publication Nos. 2008/0043318; 2008/0048970; 2009/0225398; 2010/0156780; 2011/0043543; 2012/0326957; 2013/0242378; 2013/0278995; 2014/0055840; 2014/0078576; 2014/0340430; 2014/0340736; 2014/0362213; 2015/0103394; 2015/0118390; 2015/0124345; 2015/0198858; 2015/0234250; 2015/0268531; 2015/0301246; 2016/0011484; 2016/0026062; 2016/0048054; 2016/0116816; 2016/0116818; and 2016/0140909;
(h) Methods for driving displays; see for example U.S. Pat. Nos. 5,930,026; 6,445,489; 6,504,524; 6,512,354; 6,531,997; 6,753,999; 6,825,970; 6,900,851; 6,995,550; 7,012,600; 7,023,420; 7,034,783; 7,061,166; 7,061,662; 7,116,466; 7,119,772; 7,177,066; 7,193,625; 7,202,847; 7,242,514; 7,259,744; 7,304,787; 7,312,794; 7,327,511; 7,408,699; 7,453,445; 7,492,339; 7,528,822; 7,545,358; 7,583,251; 7,602,374; 7,612,760; 7,679,599; 7,679,813; 7,683,606; 7,688,297; 7,729,039; 7,733,311; 7,733,335; 7,787,169; 7,859,742; 7,952,557; 7,956,841; 7,982,479; 7,999,787; 8,077,141; 8,125,501; 8,139,050; 8,174,490; 8,243,013; 8,274,472; 8,289,250; 8,300,006; 8,305,341; 8,314,784; 8,373,649; 8,384,658; 8,456,414; 8,462,102; 8,514,168; 8,537,105; 8,558,783; 8,558,785; 8,558,786; 8,558,855; 8,576,164; 8,576,259; 8,593,396; 8,605,032; 8,643,595; 8,665,206; 8,681,191; 8,730,153; 8,810,525; 8,928,562; 8,928,641; 8,976,444; 9,013,394; 9,019,197; 9,019,198; 9,019,318; 9,082,352; 9,171,508; 9,218,773; 9,224,338; 9,224,342; 9,224,344; 9,230,492; 9,251,736; 9,262,973; 9,269,311; 9,299,294; 9,373,289; 9,390,066; 9,390,661; and 9,412,314; and U.S. Patent Applications Publication Nos. 2003/0102858; 2004/0246562; 2005/0253777; 2007/0091418; 2007/0103427; 2007/0176912; 2008/0024429; 2008/0024482; 2008/0136774; 2008/0291129; 2008/0303780; 2009/0174651; 2009/0195568; 2009/0322721; 2010/0194733; 2010/0194789; 2010/0220121; 2010/0265561; 2010/0283804; 2011/0063314; 2011/0175875; 2011/0193840; 2011/0193841; 2011/0199671; 2011/0221740; 2012/0001957; 2012/0098740; 2013/0063333; 2013/0194250; 2013/0249782; 2013/0321278; 2014/0009817; 2014/0085355; 2014/0204012; 2014/0218277; 2014/0240210; 2014/0240373; 2014/0253425; 2014/0292830; 2014/0293398; 2014/0333685; 2014/0340734; 2015/0070744; 2015/0097877; 2015/0109283; 2015/0213749; 2015/0213765; 2015/0221257; 2015/0262255; 2015/0262551; 2016/0071465; 2016/0078820; 2016/0093253; 2016/0140910; and 2016/0180777;
(i) Applications of displays; see for example U.S. Pat. Nos. 6,118,426; 6,473,072; 6,704,133; 6,710,540; 6,738,050; 6,825,829; 7,030,854; 7,119,759; 7,312,784; 7,705,824; 8,009,348; 8,011,592; 8,064,962; 8,162,212; 8,553,012; 8,973,837; 9,188,829; and 9,197,704; and U.S. Patent Applications Publication Nos. 2002/0090980; 2004/0119681; 2007/0285385; 2013/0176288; 2013/0221112; 2013/0233930; 2013/0235536; 2014/0049808; 2014/0062391; 2014/0206292; and 2016/0035291; and International Application Publication No. WO 00/36560; and
(j) Non-electrophoretic displays, as described in U.S. Pat. Nos. 6,241,921; 6,784,953; 6,795,138; 6,914,713; 6,950,220; 7,095,477; 7,182,830; 7,245,414; 7,420,549; 7,471,369; 7,576,904; 7,580,180; 7,850,867; 8,018,643; 8,023,071; 8,282,762; 8,319,759; and 8,994,705 and U.S. Patent Applications Publication Nos. 2005/0099575; 2006/0262249; 2007/0042135; 2007/0153360; 2008/0020007; 2012/0293858; and 2015/0277160; and applications of encapsulation and microcell technology other than displays; see for example U.S. Pat. No. 7,615,325; and U.S. Patent Application Publications Nos. 2015/0005720 and 2016/0012710.

Many of the aforementioned patents and applications recognize that the wall surrounding the discrete microcapsules in an encapsulated electrophoretic medium could be replaced by a continuous phase, thus producing a so-called polymer-dispersed electrophoretic display, in which the electrophoretic medium comprises a plurality of discrete droplets of a non-polar liquid and a continuous phase of a polymeric material, and that the discrete droplets of electrophoretic medium within such a polymer-dispersed electrophoretic display may be regarded as capsules or microcapsules even though no discrete capsule membrane is associated with each individual droplet; see for example, the aforementioned 2002/0131147. Accordingly, for purposes of the present application, such polymer-dispersed electrophoretic media are regarded as sub-species of encapsulated electrophoretic media.

A related type of electrophoretic display is a so-called “microcell electrophoretic display”. In a microcell electrophoretic display, the electrically charged pigment particles and the suspending liquid are not encapsulated within microcapsules but instead are retained within a plurality of cavities formed within a carrier medium, typically a polymeric film. See, for example, International Application Publication No. WO 02/01281, and published U.S. application Ser. No. 2002/0075556, both assigned to Sipix Imaging, Inc.

Although electrophoretic media are often opaque (since, for example, in many electrophoretic media, the particles substantially block transmission of visible light through the display) and operate in a reflective mode, many electrophoretic displays can be made to operate in a so-called “shutter mode” in which one display optical state is substantially opaque and one is light-transmissive. See, for example, U.S. Pat. Nos. 6,130,774 and 6,172,798, and U.S. Pat. Nos. 5,872,552; 6,144,361; 6,271,823; 6,225,971; and 6,184,856. Dielectrophoretic displays, which are similar to electrophoretic displays but rely upon variations in electric field strength, can operate in a similar mode; see U.S. Pat. No. 4,418,346. Other types of electro-optic displays may also be capable of operating in shutter mode.

An encapsulated or microcell electrophoretic display typically does not suffer from the clustering and settling failure mode of traditional electrophoretic devices and provides further advantages, such as the ability to print or coat the display on a wide variety of flexible and rigid substrates. Use of the word “printing” is intended to include all forms of printing and coating, including, but without limitation: pre-metered coatings such as patch die coating, slot or extrusion coating, slide or cascade coating, curtain coating; roll coating such as knife over roll coating, forward and reverse roll coating; gravure coating; dip coating; spray coating; meniscus coating; spin coating; brush coating; air knife coating; silk screen printing processes; electrostatic printing processes; thermal printing processes; ink jet printing processes; electrophoretic deposition; and other similar techniques. Thus, the resulting display can be flexible. Further, because the display medium can be printed (using a variety of methods), the display itself can be made inexpensively.

One potentially important market for electrophoretic media is windows with variable light transmission. As the energy performance of buildings and vehicles becomes increasingly important, electrophoretic media could be used as coatings on windows to enable the proportion of incident radiation transmitted through the windows to be electronically controlled by varying the optical state of the electrophoretic media. Effective implementation of such “variable transmissivity” (“VT”) technology in buildings is expected to provide (1) reduction of unwanted heating effects during hot weather, thus reducing the amount of energy needed for cooling, the size of air conditioning plants, and peak electricity demand; (2) increased use of natural daylight, thus reducing energy used for lighting and peak electricity demand; and (3) increased occupant comfort by increasing both thermal and visual comfort. Even greater benefits would be expected to accrue in an automobile, where the ratio of glazed surface to enclosed volume is significantly larger than in a typical building. Specifically, effective implementation of VT technology in automobiles is expected to provide not only the aforementioned benefits but also (1) increased motoring safety, (2) reduced glare, (3) enhanced mirror performance (by using an electro-optic coating on the mirror), and (4) increased ability to use heads-up displays. Other potential applications of VT technology include privacy glass and glare-guards in electronic devices.

The art provides examples of devices comprising electrophoretic media sandwiched by electrode layers that are able to achieve a closed optical state (opaque state) and an open optical state (transparent state) and to switch between these optical states by application of electric fields across the electrophoretic medium. However, conventional electrophoretic devices using conventional structures and waveforms require long switching times. Furthermore, light from a bright object such as a light source in a dark ambient environment or specular reflections of the sun in a bright ambient environment, when it passes through the device may be subject to diffraction phenomena that can be visible or even disturbing to a viewer, making the devices less desirable. The inventors of the present invention unexpectedly found that devices comprising a microcell layer having specific architecture achieve efficient switching between the open and close optical states and improved optical performance of the open optical state.

### SUMMARY OF THE INVENTION

In one aspect, the present invention provides a variable light transmission device (200, 300, 350) according to a first embodiment. The variable light transmission device according to the first embodiment comprises a first light transmissive electrode layer (202), a second light transmissive electrode layer (207), and a microcell layer (203). The microcell layer (203) is disposed between the first light transmissive electrode layer (202) and the second light transmissive electrode layer (207). The microcell layer (203) comprises a plurality of microcells (204) and a sealing layer (206). Each microcell of the plurality of microcells (204) includes an electrophoretic medium (209), the electrophoretic medium (209) comprising electrically charged pigment particles and a non-polar liquid. Each microcell of the plurality of microcells (204) has a microcell opening (205). The sealing layer (206) spans the microcell openings (205) of the plurality of microcells (204). The sealing layer (206) of each microcell has an upper surface and a lower surface, the lower surface being in contact with the electrophoretic medium (209), the upper surface being in contact (i) with the first light transmissive electrode layer (202) or (ii) with an adhesive layer, the adhesive layer being disposed between the first light transmissive electrode layer (202) and the upper surface of the sealing layer (206). Each microcell of the plurality of microcells (204) comprises a microcell bottom layer (210), a protrusion structure (217), and a microcell wall (212). The microcell bottom layer (210) has a microcell bottom inside surface (211).

The protrusion structure (217) of a microcell of a variable light transmission device according to the first embodiment consists of a protrusion structure solid part (217a) and one or more wells (217b). The protrusion structure (217) has a protrusion base (218), an apex plane (229), and a protrusion height (220). The protrusion structure solid part (217a) has a protrusion structure solid part apex (219), a protrusion structure solid part side surface (221), and a protrusion structure solid part base (218a). The protrusion solid part apex (219) is a point or a set of points of the protrusion structure solid part (217a) having shorter distance from the microcell opening (205) than all other points of the protrusion structure solid part (217a). The apex plane (229) is a plane that is parallel to the plane of the microcell opening (205) and contains the protrusion structure solid part apex (219). The protrusion structure solid part side surface (221) is a surface of the protrusion structure solid part (217a) that is in contact with the electrophoretic medium (209) not including the protrusion structure solid part apex (219). The protrusion structure solid part base (218a) is a surface of the protrusion structure solid part (217a) that is in contact with the microcell bottom inside surface (211). The protrusion base (218) is a surface of the protrusion structure solid part and the surfaces of the one or more wells that are in contact with the microcell bottom layer (210). The protrusion height (220) is the distance between the apex plane (229) and the protrusion base (218). The protrusion structure (217) has a three-dimensional shape, the three-dimensional shape of the protrusion structure being a cylinder or a polygonal prism, the polygonal prism having a first base and a second base, the first base and the second base having each from 3 to 20 sides. The one or more wells (217b) of the protrusion structure (217) have a volume that is filled with electrophoretic medium (209). Each of the one or more wells (217b) has a three-dimensional shape consisting of one geometric solid or a combination of two or more geometric solids. The three-dimensional shape of each of the one or more wells (217b) is defined by a space between (i) the apex plane (229), (ii) the protrusion structure solid part side surface (221), and (iii) the microcell bottom inside surface (211). The one geometric solid and each of the two or more geometric solids of the three-dimensional shape of each of the one or more wells are selected from the group consisting of a cone, a conical frustum, a cylinder, a conical frustum, a polygonal pyramid, a polygonal pyramidal frustum, and a polygonal prism; the cone has a base and an apex; the conical frustum has a large base and a small base; the cylinder has a first base and a second base; the polygonal pyramid has a base and an apex, the base of the polygonal pyramid being a polygon with 3-20 sides; the polygonal pyramidal frustum has a large base and a small base, the large base and the small base of the polygonal pyramidal frustum being a polygon with 3-20 sides; and the polygonal prism has a first base and a second base, the first base and the second base of the polygonal prism being a polygon with 3-20 sides.

The microcell wall (212) of a microcell of a variable light transmission device according to the first embodiment has a microcell inside wall surface (213) and a microcell wall upper surface (214). The microcell inside wall surface (213) is a surface of the microcell wall (212) of a microcell that is in contact with the electrophoretic medium (209). The microcell wall upper surface (214) is a surface of the microcell wall (212) of a microcell that is in contact with the sealing layer (206).

In another aspect, the present invention provides a variable light transmission device (500, 550, 580, 590, 600, 650) according to a second embodiment. The variable light transmission device according to the second embodiment comprises a first light transmissive electrode layer (202), a second light transmissive electrode layer (207), and a microcell layer (203). The microcell layer (203) is disposed between the first light transmissive electrode layer (202) and the second light transmissive electrode layer (207). The microcell layer (203) comprises a plurality of microcells (204) and a sealing layer (206). Each microcell of the plurality of microcells (204) includes an electrophoretic medium (209), the electrophoretic medium (209) comprising electrically charged pigment particles and a non-polar liquid. Each microcell of the plurality of microcells (204) has a microcell opening (205), the sealing layer (206) spanning the microcell openings (205) of the plurality of microcells (204). The sealing layer (206) of each microcell has an upper surface and a lower surface, the lower surface being in contact with the electrophoretic medium (209), the upper surface being in contact (i) with the first light transmissive electrode layer (202) or (ii) with an adhesive layer, the adhesive layer being disposed between the first light transmissive electrode layer (202) and the upper surface of the sealing layer (206).

Each microcell of the plurality of microcells (204) of a variable light transmission device according to the second embodiment comprises a microcell bottom layer (210), a channel (215), a protrusion structure (217), and a microcell wall (212). The microcell bottom layer (210) has a microcell bottom inside surface (211). The microcell wall (212) has a microcell inside wall surface (213) and a microcell wall upper surface (214). The microcell inside wall surface (213) is a surface of the microcell wall (212) that is in contact with the electrophoretic medium (209). The microcell wall upper surface (214) is a surface of the microcell wall (212) that is in contact with the sealing layer (206).

The protrusion structure (217) of a microcell of a variable light transmission device according to the second embodiment consists of a protrusion structure solid part (217a) and one or more wells (217b). The protrusion structure (217) has a protrusion base (218), an apex plane (229), and a protrusion height (220). The protrusion structure solid part (217a) has a protrusion structure solid part apex (219), a protrusion structure solid part side surface (221), and a protrusion structure solid part base (218a). The protrusion solid part apex (219) is a point or a set of points of the protrusion structure solid part (217a) having shorter distance from the microcell opening (205) than all other points of the protrusion structure solid part (217a). The apex plane (229) is a plane that is parallel to the plane of the microcell opening (205) and contains the protrusion structure solid part apex (219). The protrusion structure solid part side surface (221) is a surface of the protrusion structure solid part (217a) that is in contact with the electrophoretic medium (209) not including the protrusion structure solid part apex (219). The protrusion structure solid part base (218a) is a surface of the protrusion structure solid part (217a) that is in contact with the microcell bottom inside surface (211). The protrusion base (218) is a surface of the protrusion structure solid part and the surfaces of the one or more wells that are in contact with the microcell bottom layer (210). The protrusion height (220) is the distance between the apex plane (229) and the protrusion base (218).

The protrusion structure of a microcell of a variable light transmission device of the second embodiment has a three-dimensional shape, the three-dimensional shape of the protrusion structure consisting of one geometric solid or a combination of two or more geometric solids. The one geometric solid and each of the two or more geometric solids of the three-dimensional shape of the protrusion structure are selected from the group consisting of a cylinder, a polygonal prism, a conical frustum, and a polygonal pyramidal frustum; the cylinder has a first base and a second base; the polygonal prism has a first base and a second base, the first base and the second base of the polygonal prism being a polygon with 3-20 sides; the conical frustum has a large base and a small base; the polygonal pyramidal frustum has a large base and a small base, the large base and the small base of the polygonal pyramidal frustum being a polygon with 3-20 sides.

The protrusion structure solid part side surface (221) of a microcell of a variable light transmission device of the second embodiment consists of a protrusion structure solid part inside surface (221b) and a protrusion structure solid part outside surface (221a). The protrusion structure solid part inside surface (221b) is a part of the protrusion structure solid part side surface (221) that is in contact with the one or more wells (217b). The protrusion structure solid part outside surface (221a) is a part of the protrusion structure solid part side surface (221) that is not in contact with the one or more wells (217b). The microcell bottom inside surface (211) consists of an unexposed microcell bottom inside surface (211a), a first exposed microcell bottom inside surface (211b), and a second exposed bottom inside surface (211c). The unexposed microcell bottom inside surface (211a) is in contact with the protrusion structure solid part base (218a) and not in contact with the electrophoretic medium (209). The first exposed microcell bottom inside surface (211b) and the second exposed bottom inside surface (211c) are in contact with the electrophoretic medium (209). The first exposed microcell bottom inside surface (211c) is in contact with the channel (215), and the second exposed microcell bottom inside surface (211b) is in contact with the one or more wells (217b).

The channel (215) of a microcell of a variable light transmission device of the second embodiment has a channel height (216h), an inner base perimeter (225), and an outer base perimeter (226). The channel (215) has a volume that is filled with electrophoretic medium (209). The channel is a three-dimensional shape that is defined by the protrusion structure solid part outside surface (221a), the first exposed microcell bottom inside surface (211b), the microcell inside wall surface (213), and a plane that is parallel to the first exposed microcell bottom inside surface (211b), the plane having a distance from first exposed microcell bottom inside surface (211b) equal to the channel height (216h), the channel height (216h) being 50% of the protrusion height (220). The inner base perimeter (225) is an intersection of the microcell wall (212) and the first exposed microcell bottom inside surface (211b). The outer base perimeter (226) is an intersection of the protrusion structure solid part outside surface (221a) and the first exposed microcell bottom inside surface (211b).

Each of the one or more wells (217b) of the protrusion structure (217) of a microcell of a variable light transmission device according to the second embodiment has a volume that is filled with electrophoretic medium (209). Each of the one or more wells (217b) has a three-dimensional shape consisting of one geometric solid or a combination of two or more geometric solids. The three-dimensional shape of each of the one or more wells (217b) is defined by a space between (i) the apex plane (229), (ii) the protrusion structure solid part inside surface (221b), and (iii) the second exposed microcell bottom inside surface (211c). The one geometric solid and each of the two or more geometric solids of the three-dimensional shape of each of the one or more wells are selected from the group consisting of a cone, a conical frustum, a cylinder, a conical frustum, a polygonal pyramid, a polygonal pyramidal frustum, and a polygonal prism, the cone having a base and an apex, the conical frustum having a large base and a small base, the cylinder having a first base and a second base, the polygonal pyramid having a base and an apex, the base of the polygonal pyramid being a polygon with 3-20 sides, the polygonal pyramidal frustum having a large base and a small base, the large base and the small base of the polygonal pyramidal frustum being a polygon with 3-20 sides, and the polygonal prism having a first base and a second base, the first base and the second base of the polygonal prism being a polygon with 3-20 sides.

The variable light transmission device according to the first and second embodiments has a first outer surface (250) and a second outside surface (251), the first outside surface (250) being located on a side of the variable light transmission device that is near the first light transmissive electrode layer (202), and the second outside surface (251) being located on a side of the variable light transmission device that is near the second light transmissive electrode layer (207). Application of a first electric field between the first light transmissive electrode layer (202) and the second light transmissive electrode layer (207) via a first waveform causes movement of the electrically charged pigment particles towards the one or more wells (217b), in the case of a device according to the first embodiment, or towards the one or more wells (217b) and the channel, in the case of a device according to the second embodiment, resulting in switching of the variable light transmission device to an open optical state. Application of a second electric field between the first light transmissive electrode layer (202) and the second light transmissive electrode layer (207) via a second waveform causes a movement of the electrically charged pigment particles towards the first light transmissive electrode layer (202), wherein the closed optical state has lower percent transparency than the open optical state.

The three-dimensional shape of each of the one or more wells (217b) of the protrusion structure of a microcell of the variable light transmission device of the first and second embodiments may be selected from the group consisting of (a) a cone or a polygonal pyramid, the base of the cone or polygonal pyramid being in contact with the apex plane (229) and the apex of the cone or polygonal pyramid being in contact with the microcell bottom inside surface (211); (b) a cylinder, a conical frustum, a polygonal pyramidal frustum, or a polygonal prism, the first base of the cylinder, the large base of the conical frustum, the large base of the polygonal pyramidal frustum, or the first base of the pyramidal prism being in contact with the apex plane (229) and the second base of the cylinder, the small base of the conical frustum, the small base of the polygonal pyramidal frustum, and the second base of the polygonal prism being in contact with the microcell bottom inside surface; (c) a cylinder or a first conical frustum on a cone or a second conical frustum, the first base of the cylinder being in contact with the apex plane (229), the second base of the cylinder being in contact with the base of the cone or the large base of the conical frustum, and the apex of the cone or the small base of the conical frustum being in contact with the microcell bottom inside surface; (d) a polygonal prism or a first polygonal pyramidal frustum on a polygonal pyramid or a second polygonal pyramidal frustum, the first base of the polygonal prism or the large base of the first polygonal pyramid frustum being in contact with the apex plane (229), the second base of the polygonal prism or the small base of the first polygonal pyramidal frustum being in contact with the base of the polygonal pyramid or the large base of the large polygonal pyramidal frustum, and the apex of the polygonal pyramid or the small base of the second polygonal pyramidal frustum being in contact with the microcell bottom inside surface, wherein the first and second bases of the polygonal prism, the large and small bases of the first polygonal pyramidal frustum, the base of the polygonal pyramid, and the large and small bases of the second polygonal pyramidal frustum have the same number of sides; (e) a first polygonal pyramidal frustum on a polygonal pyramid or a second polygonal pyramidal frustum or a polygonal prism, the large base of the first polygonal pyramid being in contact with the apex plane (229), the small base of the first polygonal pyramidal frustum being in contact with the base of the polygonal pyramid or the large base of the second polygonal pyramidal frustum or the first base of the polygonal prism, and the apex of the polygonal pyramid or the small base of the second polygonal pyramidal frustum being or the second base of the polygonal prism in contact with the microcell bottom inside surface, wherein the first and second bases of the first polygonal pyramidal frustum, the large and small bases of the second polygonal pyramidal frustum, the base of the polygonal pyramid, and the first and second bases of the polygonal prism have the same number of sides; (f) a first conical frustum on a cone or a second conical frustum or a cylinder, the large base of the first conical frustum being in contact with the apex plane (229), the small base of the first conical frustum being in contact with the base of the cone or large base of the second conical frustum or first base of the cylinder, and the apex of the cone or the small base of the second conical frustum or the second base of the cylinder being in contact with the microcell bottom inside surface; (g) a first cylinder on a first conical frustum on a cone or second conical frustum or second cylinder, the first base of the first cylinder being in contact with the apex plane (229), the second base of the first cylinder being in contact with the large base of the first conical frustum, the small base of the first conical frustum being in contact with the base of the cone or the large base of the second conical frustum or the first base of the second cylinder, and the apex of the cone or the small base of the second conical frustum or the second base of the second cylinder being in contact with the microcell bottom inside surface; (h) a first conical frustum on a cylinder or second conical frustum on a cone or third conical frustum, the large base of the first conical frustum being in contact with the apex plane (229), the small base of the first conical frustum being in contact with the first base of the cylinder or the large base of the second conical frustum, the second base of the cylinder or the small base of the second conical frustum being in contact with the base of the cone or the large base of the third conical frustum, and the apex of the cone or the small base of the third conical frustum being in contact with the microcell bottom inside surface; (i) a first conical frustum on a second conical frustum on a cone or third conical frustum or a cylinder, the large base of the first conical frustum being in contact with the apex plane (229), the small base of the first conical frustum being in contact with the large base of the second conical frustum, the small base of the second conical frustum being in contact with the base of the cone or the large base of the third conical frustum or the first base of the cylinder, and the apex of the cone or the small base of the third conical frustum or the second base of the cylinder being in contact with the microcell bottom inside surface; (j) a first polygonal pyramidal frustum on a pyramidal prism or second polygonal pyramidal frustum on a polygonal pyramid or third polygonal pyramidal frustum, the large base of the first polygonal pyramidal frustum being in contact with the apex plane (229), the small base of the first polygonal pyramidal frustum being in contact with the first base of the pyramidal prism or the large base of the second polygonal pyramidal frustum, the second base of the pyramidal prism or the small base of the second polygonal pyramidal frustum being in contact with the base of the polygonal pyramid or the large base of the third polygonal pyramidal frustum, and the apex of the pyramidal prism or the small base of the third polygonal pyramidal frustum being in contact with the microcell bottom inside surface, wherein the large and small bases of the first polygonal pyramidal frustum, the first and second bases of the pyramidal prism, the large and small bases of the second polygonal pyramidal frustum, the base of the polygonal pyramid, and the large and small bases of the third polygonal pyramidal frustum have the same number of sides; and (k) a first polygonal pyramidal frustum on a second polygonal pyramidal frustum on a polygonal pyramid or third polygonal pyramidal frustum or a polygonal prism, the large base of the first polygonal pyramidal frustum being in contact with the apex plane (229), the small base of the first polygonal pyramidal frustum being in contact with the large base of the second polygonal pyramidal frustum, the small base of the second polygonal pyramidal frustum being in contact with the base of the cone or the large base of the third conical frustum or the first base of the cylinder, and the apex of the polygonal pyramid or the small base of the third polygonal pyramidal frustum or the second base of the polygonal prism in contact with the microcell bottom inside surface, wherein the large and small bases of the first, second, and third polygonal pyramidal frustum, the first and second bases of the pyramidal prism, and the base of the polygonal pyramid have the same number of sides.

The three-dimensional shape of the protrusion structure (217) of the protrusion structure of a microcell of the variable light transmission device of the first and second embodiments may be selected from the group consisting of (a) a cylinder, the first base of the cylinder being the protrusion base (218) and the second base of the cylinder being in contact with the apex plane (229); (b) a polygonal prism, the first base of the polygonal prism being the protrusion base (218) and the second base of the polygonal prism being in contact with the apex plane (229), the first base and the second base having each from 3 to 20 sides; (c) a conical frustum, the large base of the conical frustum being the protrusion base (218) and the small base of the conical frustum being in contact with the apex plane (229); (d) a polygonal pyramidal frustum, the large base of the polygonal pyramidal frustum being the protrusion base (218), the small base of the polygonal pyramidal frustum being in contact with the apex plane (229), the large base and the small base of the polygonal pyramidal frustum each having the same number of sides, the number of sides being from 3 to 20 sides; (e) a first conical frustum on a cylinder or a second conical frustum, the first base of the cylinder or the large base of the second conical frustum being the protrusion base (218), the second base of the cylinder or the small base of the second conical frustum being in contact with the large base of the first conical frustum, the small base of the first conical frustum being in contact with the apex plane (229); and (f) a first polygonal pyramidal frustum on an polygonal prism or a second polygonal pyramidal frustum, the first base of the polygonal prism or the large base of the second pyramidal frustum being the protrusion base (218), the second base of the polygonal prism or the small base of the second pyramidal frustum being in contact with the large base of the first polygonal pyramidal frustum, and the small base of the first polygonal pyramidal frustum being in contact with the apex plane (229), wherein the large and small base of the first and second polygonal pyramidal frustum and the first and second bases of the pyramidal prism each have the same number of sides, the number of sides being from 3 to 20 sides.

The microcell opening (205) of each microcell of the plurality of microcells (204) of the microcell layer (203) of the variable light transmission device according to the first and second embodiments may have a shape, the shape of the microcell opening (205) being selected from the group consisting of a circle, an ellipse, a square, a rectangle, and a polygon, the polygon having 5 to 12 sides.

Each microcell of the plurality of microcells (204) of the microcell layer (203) of the variable light transmission device according to the first and second embodiments may have a length of from 400 micrometers to 800 micrometers and a height of from 20 micrometers to 100 micrometers.

The variable light transmission device according to the first and second embodiments may comprise (i) an adhesive layer, the adhesive layer being disposed between the first light transmissive electrode layer (202) and the sealing layer (206), (ii) a second adhesive layer, the second adhesive layer being disposed between the microcell layer (203) and the second light transmissive electrode layer (207), or (iii) both the adhesive layer and the second adhesive layer.

The variable light transmission device according to the first and second embodiments may comprise a light blocking layer (230) disposed between the microcell wall upper surface (214) and the sealing layer (206), the light blocking layer (230) comprising light absorbing pigment. The light absorbing pigment of the light blocking layer (230) may have black color.

The electrically charged pigment particles (223) of the electrophoretic medium (209) of the variable light transmission device according to the first and second embodiments may be light absorbing.

When the second electric field is applied between the first light transmissive electrode layer (202) and the second light transmissive electrode layer (207) of the variable light transmission device according to the first and second embodiments that causes the movement of the electrically charged pigment particles (223) towards the first light transmissive electrode layer (202) with a velocity, the velocity may have a lateral component.

The first electric field, which is applied via a first waveform between the first light transmissive electrode layer (202) and the second light transmissive electrode layer (207) of the variable light transmission device according to the first and second embodiments that causes movement of the electrically charged pigment particles towards the one or more wells (217b), resulting in switching of the variable light transmission device to an open optical state, may have a net positive or net negative impulse; the second waveform may comprise an AC waveform, the AC waveform having a duty cycle of from 5% to 45%; the second waveform may comprise a DC-offset waveform, which is formed by a superposition of a DC voltage component and an AC waveform.

The variable light transmission device according to the second embodiment may comprise a microcell having a protrusion structure comprising from 1 to 3 wells, from 1 to 5 wells, from 1 to 10 wells, from 1 to 15 wells, from 1 to 20 wells, from 1 to 30 wells, from 2 to 5 wells, from 2 to 10 wells, from 2 to 15 wells, from 2 to 20 wells, from 2 to 30 wells, from 5 to 25 wells, or from 5 to 30 wells. The variable light transmission device according to the second embodiment may comprise a microcell layer, each of the plurality of microcells of the microcell layer having a protrusion structure comprising from 1 to 3 wells, from 1 to 5 wells, from 1 to 10 wells, from 1 to 15 wells, from 1 to 20 wells, from 1 to 30 wells, from 2 to 5 wells, from 2 to 10 wells, from 2 to 15 wells, from 2 to 20 wells, from 2 to 30 wells, from 5 to 25 wells, or from 5 to 30 wells.

The variable light transmission device according to the first embodiment may comprise a microcell having a protrusion structure comprising from 1 to 3 protrusion, from 1 to 5 wells, from 1 to 10 wells, from 1 to 15, from 1 to 20 wells, from 1 to 30 wells, from 1 to 35 wells, from 1 to 39 wells, from 10 to 20 wells, from 10 to 39 wells, from 2 to 5 wells, from 2 to 10 wells, from 2 to 15, from 2 to 20 wells, from 2 to 30 wells, from 2 to 35 wells, from 2 to 39 wells, from 10 to 25 wells, from 10 to 30 wells, from 10 to 39 wells, from 15 to 39 wells, or from 20 to 39 wells. The variable light transmission device according to the first embodiment may comprise a microcell layer, each of the plurality of microcells of the microcell layer having a protrusion structure comprising from 1 to 3 protrusion, from 1 to 5 wells, from 1 to 10 wells, from 1 to 15, from 1 to 20 wells, from 1 to 30 wells, from 1 to 35 wells, from 1 to 39 wells, from 10 to 20 wells, from 10 to 39 wells, from 2 to 5 wells, from 2 to 10 wells, from 2 to 15, from 2 to 20 wells, from 2 to 30 wells, from 2 to 35 wells, from 2 to 39 wells, from 10 to 25 wells, from 10 to 30 wells, from 10 to 39 wells, from 15 to 39 wells, or from 20 to 39 wells.

The channel of the variable light transmission device according to the second embodiment may have a width of from 5 micrometers to 30 micrometers, 10 micrometers to 30 micrometers, from 15 micrometers to 20 micrometers, or from 10 micrometers to 20 micrometers.

The well of the variable light transmission device according to the first and second embodiments may have a width of from 5 micrometers to 30 micrometers, from 5 micrometers to 20 micrometers, from 10 micrometers to 20 micrometers, or from 10 micrometers to 25 micrometers.

The inside wall surface (213) and the microcell bottom surface (211) of a microcell of the variable light transmission device according to the second embodiment may form an angle (φ), the angle (φ) being from 90 to 120 degrees.

### BRIEF DESCRIPTION OF DRAWINGS

FIG. 1 is an illustration of a cylindrical particle in a liquid under the influence of an applied electric field and resulting forces on the particle.

FIGS. 2A and 2B illustrate a side view of an example of a microcell of a variable light transmission device of the first embodiment of the present invention.

FIGS. 3A and 3B illustrate a side view of an example a microcell of a variable light transmission device of the first embodiment of the present invention.

FIGS. 4A, 4B, 4C, and 4D illustrate side views of examples of various wells.

FIGS. 5A and 5B illustrate a side view of an example of a microcell of a variable light transmission device of the second embodiment of the present invention.

FIG. 5C is a prospective view of the microcell of the variable light transmission device according to the second embodiment, the microcell having 22 wells.

FIGS. 6A and 6B illustrate a side view of an example of a microcell of a variable light transmission device of the second embodiment of the present invention.

FIG. 7 illustrates a side view of a portion of an example of a variable light transmission device of the second embodiment of the present invention; the side view comprises four microcells.

FIGS. 8A to 8F illustrate side views of examples of wells of protrusion structures of microcells of the variable light transmission device of the present invention.

FIG. 9 illustrates a side view of an example of a microcell of a variable light transmission device of the second embodiments at an open optical state.

FIG. 10 illustrates a side view of an example of a microcell of a variable light transmission device of the second embodiments at a closed optical state.

FIG. 11 is an example of a second waveform that can be applied on a variable light transmittance device of the present invention to achieve a closed optical state; this example comprises a DC-imbalanced waveform that includes an AC waveform having a duty cycle that is higher than 50%.

FIG. 12 is another example of a second waveform that can be applied on a variable light transmittance device of the present invention device to achieve a closed optical state; the waveform is a superposition of a DC voltage component and an AC waveform.

FIG. 13 illustrates a force exerted by an electrically charged pigment particle on the surface of a conical protrusion of the variable light transmission device of the present invention.

FIG. 14 illustrates a side view of an example of a microcell of a variable light transmission device of the second embodiment; the microcell of this example comprises a light blocking layer on the microcell wall upper surface.

FIG. 15 illustrates a side view of an example of a microcell of a variable light transmission device of the second embodiment; the microcell wall inside surface and the microcell bottom surface of the microcell of this example form an angle (φ), the angle (φ) being higher than 90 degrees.

FIG. 16 illustrates a side view of an example of a microcell of a variable light transmission device of the second embodiment; the microcell comprises a protrusion structure, the protrusion structure being a first conical frustum on a second conical frustum; the slope of the first conical frustum is smaller than the slope of the second conical frustum.

FIG. 17 illustrates a side view of an example of a microcell of a variable light transmission device of the second embodiment; the microcell comprises a protrusion structure, the protrusion structure being a first conical frustum on a second conical frustum; the slope of the first conical frustum is smaller than the slope of the second conical frustum; the microcell wall inside surface and the microcell bottom surface of the microcell of this example form an angle (φ), the angle (φ) being higher than 90 degrees.

FIG. 18A illustrates a top view of a portion of a variable light transmission device having a plurality of microcells, each of the plurality of microcells having hexagonal inner and outer base perimeters.

FIG. 18B shows a Fraunhofer diffraction pattern formed by a circular aperture and a Fraunhofer diffraction pattern formed by the hexagonal aperture of the device, a portion of the plurality of microcells of which is illustrated in FIG. 18A.

FIG. 19A illustrates a side view of an example of a microcell of a variable light transmission device of the first embodiment; the microcell, which does not comprise a channel, has a cylindrical protrusion structure.

FIG. 19B shows a Fraunhofer diffraction pattern formed by the variable light transmission device, a microcell of which is illustrated in FIG. 19A.

FIG. 20A illustrates a side view of an example of a microcell of a variable light transmission device of the second embodiment; the microcell is a geometric solid that is a conical frustum on a cylinder.

FIG. 20B illustrates a top view of an example of a microcell of the variable light transmission device, the side view of a microcell of which is illustrated in FIG. 20A.

FIG. 21 shows a Fraunhofer diffraction pattern formed by the variable light transmission device, a microcell of which is illustrated in FIG. 20A (circular aperture).

FIG. 22 illustrates a top view of an example of a microcell of a variable light transmission device of the second embodiment; the microcell comprises a channel and a protrusion structure having a well.

### DETAILED DESCRIPTION OF THE INVENTION

As used herein, a “variable light transmission device” is a device comprising an electrophoretic medium, wherein the quantity of transmitted light through the device can be controlled by application of electric field across the electrophoretic medium.

“First outside surface of a variable light transmission device” and “second outside surface of a variable light transmission device” are the outside surface of the device that are parallel to the first light transmissive electrode layer and the second light transmissive electrode layer, respectively. The term “outside surface” as used herein, only refers to the main surfaces on the viewing sides of the variable light transmission device, not the smaller surface on the periphery of the device.

“First exposed microcell bottom inside surface” is the part of a microcell bottom surface of a microcell of a variable light transmissive device of the second embodiment that is in contact with the channel of a variable light transmission device. The channel is filled with electrophoretic medium. Thus, the first exposed microcell bottom inside surface is in contact with the electrophoretic medium of the microcell. On the contrary, “unexposed microcell bottom inside surface” is not in contact with the electrophoretic medium of a microcell. The unexposed microcell bottom inside surface is the part of the microcell bottom surface of a microcell of a variable light transmissive device of the first and second embodiment that is in contact with the protrusion structure solid part base (218a). “Second exposed microcell bottom inside surface” is the part of a microcell bottom surface of a microcell of a variable light transmissive device of the second embodiment that is in contact with the protrusion structure well of a variable light transmission device. The protrusion structure well is filled with electrophoretic medium. Thus, the second exposed microcell bottom inside surface is in contact with the electrophoretic medium of the microcell.

When the term “in contact with the electrophoretic medium”, referring to a surface in a microcell, is used herein, it is assumed that the entire available volume of a microcell is filled with the electrophoretic medium. Available volume is the volume of the microcell that is not occupied by solid.

“Percent transparency of a variable light transmission device” (% T) at a location of the device is given by Equation 1. Thus, “percent transparency of a variable light transmission device” (% T) at a location of the device is the ratio of the intensity of light that is transmitted through the variable light transmission device and exiting from a location of the second outside surface of the variable light transmission device (I) to the intensity of light that enters the variable light transmission device from a location at the first outside surface of the variable light transmission device (Io) times 100; the location of the second outside surface is symmetrical to the location of the first outside surface with respect to a plane, the plane being at equal distance between the first light transmissive electrode layer and the second light transmissive electrode layer.

$$\% T = ( I / Io ) \times 100 \qquad ( Equation 1 )$$

The distance of a point from a plane is the shortest perpendicular distance from the point to the plane. The shortest distance from a point to a plane is the length of the perpendicular parallel to the normal vector dropped from the given point to the given plane.

The distance between two planes in a three-dimensional space is the shortest distance between the planes. It is the shortest distance between any point on one plane and any point on the other plane.

The term “cone”, as used herein, includes cones that have a circular base or an elliptical base.

“A frustum” is the base portion of a cone or a polygonal pyramid obtained by cutting the apex portion with a plane parallel to the base. It is also called a flat-top cone or pyramid because it does not have an apex but has two parallel bases.

The term “conical frustum”, as used herein, includes conical frustums that have circular or elliptical bases.

Slope of a cone is defined as the angle that has (a) vertex (A) on the circumference of the base of the cone, (b) first arm the line that connects point A (vertex) and the center of the base of the cone C, and (c) second arm the line that connects point A (vertex) and the apex of the cone.

Slope of a conical frustum is defined as the angle that has (a) vertex (A) on the circumference of the bottom (large) base of the cone, (b) first arm is the line that connects point A (vertex) and the center of the bottom base of the conical frustum C, and (c) second arm the line that is the intersection of the lateral surface of the conical frustum and a plane that includes the linear segment AC, the plane being vertical to the bottom base of the conical frustum.

Slope of a polygonal pyramid is defined as the angle that has (a) vertex (A) on a point of the perimeter of the base of the polygonal pyramid, (b) first arm the line that connects point A (vertex) and the center of the base of the polygonal pyramid, and (c) second arm the line that connects point A (vertex) and the apex of the cone. Slope of a polygonal pyramidal frustum is defined as the angle that has (a) vertex (A) on a point of the perimeter of the bottom (large) base of the polygonal pyramid, (b) first arm the line that connects point A (vertex) and the center of the bottom base of the polygonal pyramidal frustum, and (c) second arm the line that is the intersection of the lateral surface of the polygonal pyramidal frustum and a plane that includes the linear segment AC, the plane being vertical to the bottom base of the polygonal pyramidal frustum.

The term “electrically charged pigment particles” may refer to electrically charged pigment particles that may have or may not have on the surface of the pigment particles. As used herein, the term “electrically charged pigment particles” is synonymous to the term “electrophoretic particles”.

A “microcell wall inside surface” is the surface of the microcell wall that is in contact with the electrophoretic medium of the microcell. As mentioned above, for this definition, it is assumed that the entire available volume of the microcell is filled with the electrophoretic medium.

A “microcell wall upper surface” is the surface of the microcell wall that is in contact with the sealing layer of the microcell. In the case that there is a light blocking layer on the microcell wall upper surface, the light blocking layer is disposed between the microcell wall upper surface and the sealing layer.

“Length of a microcell” is the longest distance between any point of the microcell opening (205) to any other point of the microcell opening (205). “Height of a microcell” is the distance between the plane that includes the microcell opening (205) and the plane that includes the microcell bottom inside surface (211).

“Channel base width” (216w) is the smallest distance between the inner base perimeter (224) and outer base perimeter (225) of the channel of a microcell.

As used herein, a surface being on plane A being in contact with another surface being on plane B, means that the two planes are parallel and all their points are touching each other. For example, when a base A of a first geometric solid is in contact with a base B of a second geometric solid, the plane that includes the surface of base A is parallel to the plane that includes the surface of base B and the two planes are touching each other.

The term “DC-balanced waveform” or “DC-balanced driving waveform” applied to a pixel is a driving waveform where the driving voltage applied to the pixel is substantially zero when integrated over the period of the application of the entire waveform. The DC balance can be achieved by having each stage of the waveform balanced, that is, a first positive voltage will be chosen such that integrating over the subsequent negative voltage results in zero or substantially zero. If the waveform is not DC-balanced, it is referred to as “DC-imbalanced waveform” or “DC-imbalanced driving waveform”. The driving waveform applied to a pixel may have a portion that is DC-imbalanced and at least one additional pulse of the opposite impulse to ensure that the overall waveform applied to a pixel is DC-balanced. This additional pulse may be applied before the DC-imbalanced portion of the waveform (pre-pulse). Typical examples of DC-imbalanced waveforms include (a) a square or sinusoidal AC waveform having a duty cycle of less (or more) than 50%, and (b) square or sinusoidal AC waveform that has a DC offset.

The term “impulse” is the integral of voltage with respect to time. That is, for a waveform pulse having a voltage V applied for time t, the impulse is V×t. The impulse can be positive, if the polarity of voltage V is positive, or negative, if the polarity of voltage V is negative.

The term “net positive impulse” of a waveform means that negatively electrically charged pigment particles will be attracted to and will move towards the first light transmissive electrode layer during the application of the waveform.

The term “lateral component of velocity” in relation to the movement of electrically charged pigment particles in a microcell of the variable light transmission device of the present invention is the velocity in the horizontal direction. For this definition, we assume that the velocity of the electrically charged particles is a vector resulting from the vector addition of the velocity in the horizontal direction (Vt), and the velocity in the vertical direction (Vv), and that the vertical direction in the case of the movement of the electrically charged pigment particles inside an electrophoretic microcell is the direction from the first light transmissive electrode layer to the second light transmissive electrode layer or form the second light transmissive electrode layer to the first light transmissive electrode layer. In the same system, the horizontal direction of the movement of the electrically charged pigment particles inside an electrophoretic microcell is the direction from one side of the microcell wall to the other side of the microcell wall, this direction being parallel to the first light transmissive electrode layer. Thus, the statement “the velocity of the electrically charged pigment particles has a lateral component” means that the magnitude of the velocity in the horizontal direction is larger than zero.

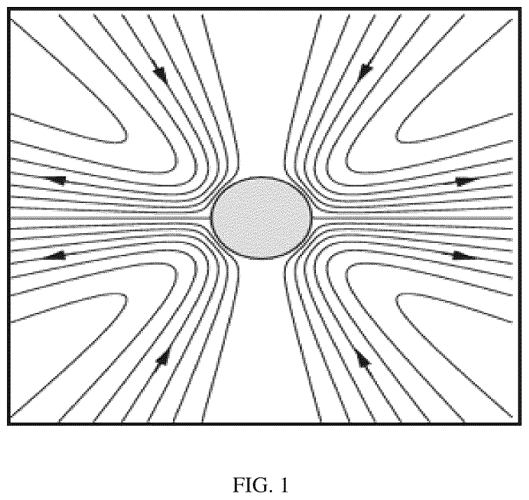

The phenomenon of Induced-Charge-Electro-Osmosis (ICEO) can be utilized to move polarizable particles, such as pigment particles, which are present in an electrophoretic medium, laterally. That is, the polarizable particles can move parallel to the electrode layers that sandwich the electrophoretic medium. In the presence of an electric field, a particle may experience a force, which is caused by polarization of the particle (or by polarization of an adsorbed conductive coating on the particle surface, or of the electrical double layer around the particle). This force may result in a perturbation in the flow of mobile charge, such as ions or charged micelles, in the electrophoretic medium, as shown in FIG. 1 for a cylindrical particle 101 surrounded by the liquid of the electrophoretic medium in the applied electric field. This figure is reproduced by the article of Bazant and Squires, J. Fluid Mech., 2004, 509, 217-252.

A perfectly symmetrical, spherical particle would experience no net force, but less symmetrical particles would experience forces having a component perpendicular to the direction of the applied field. The cooperative flows, which are created by a swarm of particles each experiencing such forces, can lead to “swirling” of an electrophoretic medium containing multiple particles. The maximum velocity u of this swirling for a particular particle, according to the theory advanced in the article by Bazant and Squires, would be given approximately by Expression 1.

$$u ∝ \frac{ε {RE}^{2}}{η ( 1 + {ω}^{2} {τ}^{2} )} \qquad ( Expression 1 )$$

In Expression 1, E is the field strength, ε is the dielectric constant of the solvent, η is the viscosity of the electrophoretic fluid, ω is the applied sinusoidal AC frequency, and τ is the time scale for building up a screening charge layer by motion of solvent-borne charges around charge. The time scale τ is given by Equation 3.

$$τ = \frac{{λ}_{D} R}{D} \qquad ( Equation 3 )$$

In Equation 3, λ_{D} is the Debye screening length, R is the particle radius, and D is the diffusion constant of charge carriers in the fluid.

According to Expression 1, as the frequency is raised, the value of ω²τ² increases, and the maximum velocity of induced-charge flows decreases. Furthermore, for values of @²τ² that are significantly larger than 1, the maximum swirling velocity is proportional to the square of the ratio E/ω. Induced-charge flows occur in the same direction regardless of the polarity of the applied electric field and can thus be driven by alternating fields.

When the electrophoretic medium is contained within a microcell, as is preferred in electrophoretic displays, the geometries of the induced flows are affected by the shape of the microcell used. For example, in the simplest case of two parallel electrodes, it was shown that, using an appropriate electric field strength and AC frequency, the flow can adopt a roll structure with periodic spacing that corresponds to the width of the gap between the electrodes.

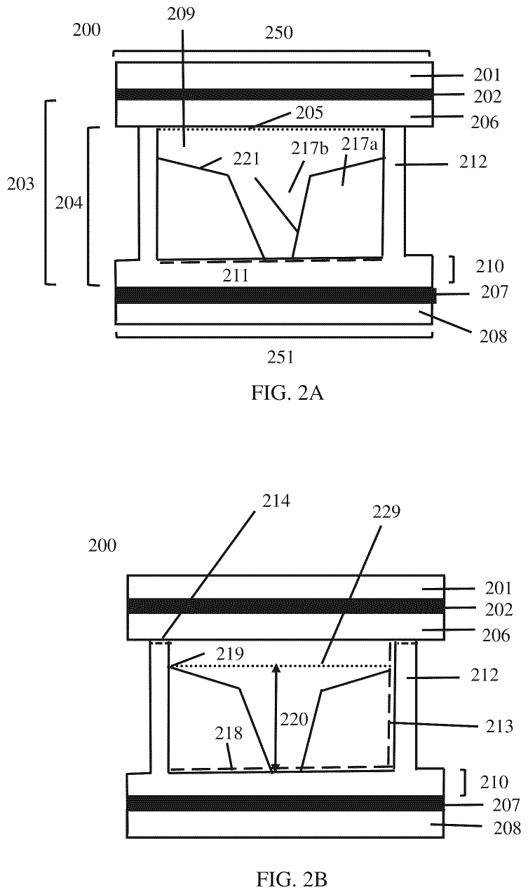

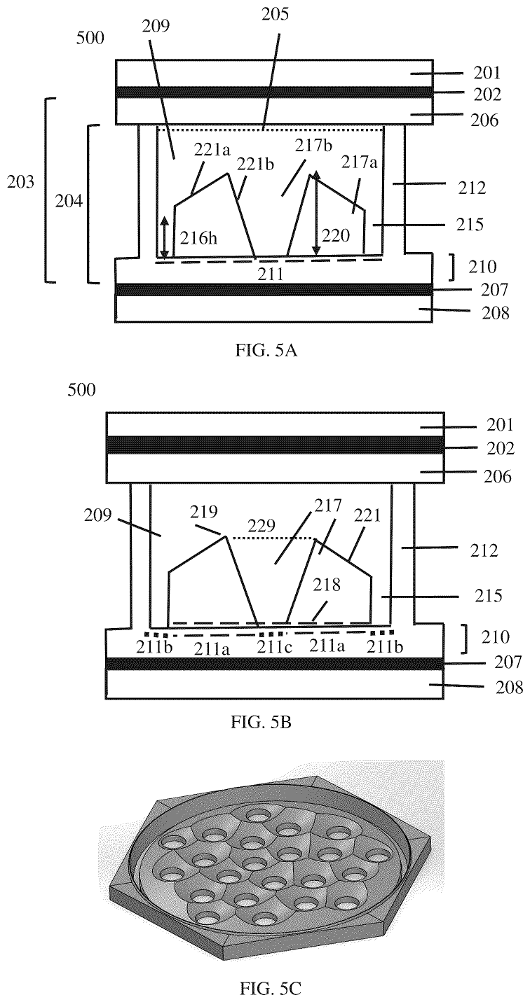

The inventors of the present invention used complex microcell structures that were formed by an embossing method to make variable light transmission devices. In one example, the embossed structure includes a protrusion structure on the bottom inside surface of each microcell. FIGS. 2A, 2B, 3A, 3B, and 18 illustrate examples of the first embodiment of variable light transmission devices according to the present invention. The first embodiment includes variable light transmission devices that comprise microcells, the microcells not comprising a channel. FIGS. 5A, 5B, 6A, 6B, 7, 8, 9, 13, 14, 16, 15, 17, and 20 illustrate examples of the second embodiment of variable light transmission devices according to the present invention. The second embodiment includes variable light transmission devices that comprise microcells having a channel.

FIGS. 2A and 2B illustrate a side view of an example of a microcell of variable light transmission device 200 according to the first embodiment. FIGS. 2A and 2B illustrate a cross-section (side view) of the same device. That is, the figure of FIG. 2A is repeated in FIG. 2B to facilitate the identification of the various parts and components of the device. These figures illustrate only a portion of the display (not in scale), showing only one microcell of the plurality of microcells of the device. Variable light transmission device 200 comprises, in order, a first light transmissive substrate (201), a first light-transmissive electrode layer (202), a microcell layer (203), a second light-transmissive electrode layer (207), and a second light transmissive substrate (208). Microcell layer 203 is disposed between first light transmissive electrode layer 202, a second light transmissive electrode layer 207, and a second light transmissive substrate (208). Microcell layer 203 comprises a plurality of microcells (204) and a sealing layer (206). Each microcell of the plurality of microcells (204) includes an electrophoretic medium (209), the electrophoretic medium (209) comprising electrically charged pigment particles and a non-polar liquid (not shown in FIGS. 2A and 2B). Each microcell of the plurality of microcells (204) has a microcell opening (205), the sealing layer (206) spanning the microcell openings (205) of the plurality of microcells (204). Each microcell of the plurality of microcells (204) comprises a microcell bottom layer (210), a protrusion structure (217), and a microcell wall (212), the microcell bottom layer (210) having a microcell bottom inside surface (211). The variable light transmission device of the present invention has a first outer surface (250) and a second outside surface (251). The first outside surface (250) is located on a side of the variable light transmission device that is near the first light transmissive electrode layer (202), and the second outside surface (251) is located on a side of the variable light transmission device that is near the second light transmissive electrode layer (207).

The protrusion structure (217) of the device of FIGS. 2A and 2B consists of a protrusion structure solid part (217a) and a well (217b). The protrusion structure solid part (217a) comprises a protrusion structure solid part apex (219), a protrusion structure solid part side surface (221), a protrusion base (218), a protrusion height (220), and an apex plane (229). The protrusion structure solid part base, which is the surface of the protrusion structure solid part that is in contact with the microcell bottom layer (210), or equivalently in contact with the microcell bottom inside surface (211), is not labeled in FIGS. 2A and 2B. The protrusion solid part apex (219) is a point or a set of points of the protrusion structure solid part (217a) having shorter distance from the microcell opening (205) than all other points of the protrusion structure solid part (217a). The apex plane (229) is a plane that is parallel to the plane of the microcell opening (205) and contains the protrusion structure solid part apex (219). The protrusion structure solid part side surface (221) is a surface of the protrusion structure solid part (217a) that is in contact with the electrophoretic medium (209) not including the protrusion structure solid part apex (219). In the case where the protrusion solid part apex (219) is a set of points, the set of points may form a surface, which is not part of the protrusion structure solid part side surface (221). Even in the case where the protrusion structure apex is not a surface but only a point or a set of a limited number of points, as in the example of the device of FIGS. 2A and 2B, the point or the set of a limited number of points are not part of the protrusion structure solid part side surface (221), according to the definition of the protrusion structure solid part side surface (221). In other words, the total surface of the protrusion structure solid part which is in contact with the electrophoretic medium (209) is the combination of the protrusion structure solid part side surface (221) and the surface formed by the protrusion solid part apex. The protrusion height (220) is the distance between the apex plane (229) and the protrusion base (218).

The protrusion structure has a three-dimensional shape. In the example of the device of FIGS. 2A and 2B, the three-dimensional shape of the protrusion structure is a cylinder. The first base of the cylinder is the protrusion base 218 and the second base of the cylinder is in contact with the apex plane 229. The protrusion structure height is the distance between the protrusion base (218) and the apex plane 229.

The well has a three-dimensional shape. The whole volume of the well is filled with electrophoretic medium (209). The three-dimensional shape of each of the one or more wells (217b) is defined by a space between (i) the apex plane (229), (ii) the protrusion structure solid part side surface (221), and (iii) the microcell bottom inside surface (211). In the example of the device of FIGS. 2A and 2B, there is only one well, three-dimensional shape of which consist of two geometric solids, a first conical frustum on a second conical frustum. The large base of the first conical frustum is in contact with the apex plane 229; the small base of the first conical frustum is in contact with the large base of the second conical frustum, and the small base of the second conical frustum is in contact with the microcell bottom layer 210.

The microcell wall 212 of the microcell, which is illustrated in FIGS. 2A and 2B, has a microcell wall inside surface 213 and microcell wall upper surface 214. The microcell wall inside surface 213 is in contact with electrophoretic medium 209. The microcell wall upper surface 214 is the surface of microcell wall 212 of a microcell that is in contact with sealing layer 206.

In the example of variable light transmission device 200 of FIGS. 2A and 2B, the protrusion structure (the combination of protrusion structure solid part 217a and well 217b) may also be a polygonal prism having from 3 to 20 sides. The polygonal prism has two bases, a first base and a second base. The first base is in contact with the apex plane (229), and the second base is the protrusion base (218). Well 217b of variable light transmission device 200 may be a first polygonal pyramidal frustum on a second polygonal pyramidal frustum. The first polygonal pyramidal frustum has a smaller base and a larger base. Analogously, the second polygonal pyramidal frustum has a small base and a large base. All the bases of the first and second polygonal pyramidal frustums may be polygons having the same number of sides (from 3 to 20 sides). The large base of the first polygonal pyramidal frustum is in contact with the apex plane 229. The small base of the first polygonal pyramidal frustum is in contact with the larger base of the second polygonal pyramidal frustum. The small base of the second polygonal pyramidal frustum is in contact with the microcell bottom inside surface 211.

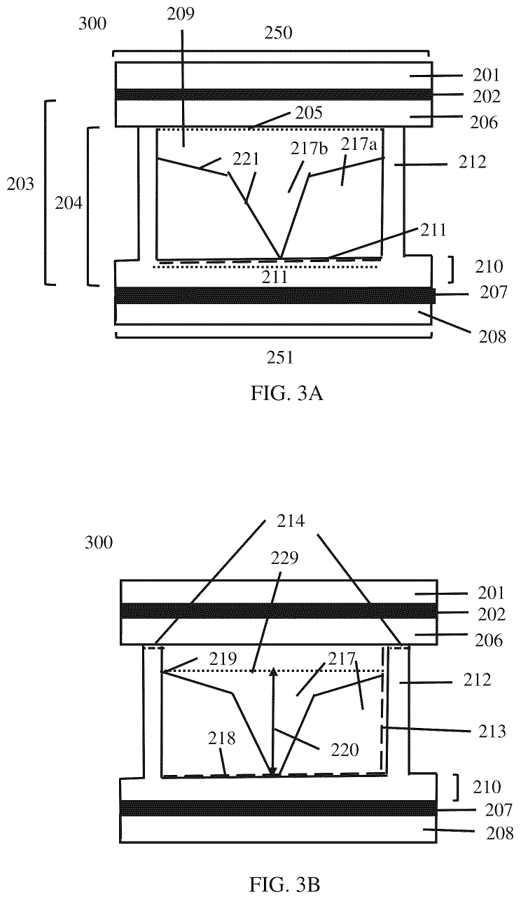

Variable light transmission device 300 of FIGS. 3A and 3B has similar structure to the variable light transmission device 200 of FIGS. 2A and 2B. The only difference is related to the three-dimensional shape of the well 217b. Specifically, protrusion structure 217 of the microcell of variable light transmission device 300 may be a cylinder or a polygonal prism, as in the microcell of variable light transmission device 200. However, well 217b of the protrusion structure 217 of variable light transmission device 300 is a conical frustum on a cone. The conical frustum has a large base and a small base and the cone has a base and an apex. The large base of the conical frustum is part of the apex plane 229. The small base of the conical frustum is in contact with the base of the cone. The apex of the cone in the microcell of variable light transmission device 300 is part of the protrusion base 218, which is in contact with the microcell bottom inside surface 211.

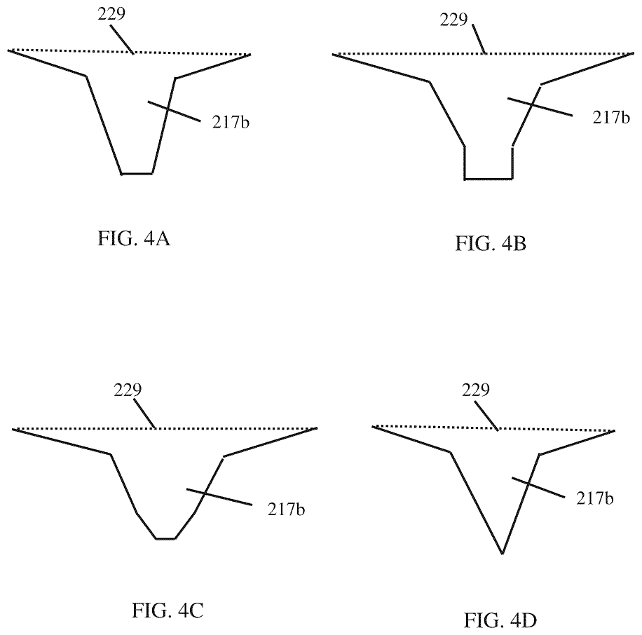

FIGS. 4A, 4B, 4C, and 4D illustrate side views of wells 217b having various three-dimensional shapes of wells of a microcell of variable light transmission device according to the first embodiment. Specifically, FIG. 4A illustrates a well that is a three-dimensional shape that consist of a first conical frustum on a second conical frustum, or a first polygonal pyramidal frustum on a second polygonal pyramidal frustum, the first polygonal pyramidal frustum and the second polygonal pyramidal frustum having from 3 to 20 sides. The slope of the first conical frustum is smaller than the slope of the second conical frustum, or the slope of the first polygonal pyramidal frustum is smaller than the slope of the second polygonal pyramidal frustum. FIG. 4B illustrates a well that has a three-dimensional shape consisting of a first conical frustum on a second conical frustum on a cylinder, or a first polygonal pyramidal frustum on a second polygonal pyramidal frustum on a polygonal prism, the first polygonal pyramidal frustum, the second polygonal pyramidal frustum, and the polygonal prism having from 3 to 20 sides. The slope of the first conical frustum is smaller than the slope of the second conical frustum, or the slope of the first polygonal pyramidal frustum is smaller than the slope of the second polygonal pyramidal frustum. FIG. 4C illustrates a well that has a three-dimensional shape that consist of a first conical frustum on a second conical frustum on a third conical frustum, or a first polygonal pyramidal frustum on a second polygonal pyramidal frustum on a third polygonal pyramidal frustum, the first polygonal pyramidal frustum, the second polygonal pyramidal frustum, and the third polygonal pyramidal frustum having from 3 to 20 sides. The slope of the first conical frustum is smaller than the slope of the second conical frustum and the slope of the second conical frustum is smaller than the slope of the third conical frustum, or the slope of the first polygonal pyramidal frustum is smaller than the slope of the second polygonal pyramidal frustum and the slope of the second polygonal pyramidal frustum is smaller than the slope of the third polygonal pyramidal frustum. FIG. 4D illustrates a well that has a here-dimensional shape consisting of a conical frustum on a cone, or a polygonal pyramidal frustum on a polygonal prism, the polygonal pyramidal frustum and the polygonal prism having from 3 to 20 sides. The slope of the conical frustum is smaller than the slope of the cone, or the slope of the polygonal pyramidal frustum is smaller than the slope of the polygonal pyramid. For reference, the apex plane 229 is shown in FIGS. 4A-4D. The slopes of the geometric solids of the well of the various variable light transmission devices of the first embodiment enable the charged electrophoretic pigment particles to be collected in the well of the protrusion structure to form the open optical state of the device.

FIGS. 5A and 5B illustrate examples of portions of variable light transmission device 200 according to the second embodiment. FIGS. 5A and 5B illustrate a cross-section (side view) of the same light transmission device. That is, the figure of FIG. 5A is repeated in FIG. 5B to facilitate the identification of the various parts and components of the device. These figures illustrate only a portion of the display (not in scale), showing only one microcell of the plurality of microcells of the device. Variable light transmission device 500 comprises, in order, a first light transmissive substrate (201), a first light-transmissive electrode layer (202), a microcell layer (203), a second light-transmissive electrode layer (207), and a second light transmissive substrate (208). Microcell layer 203 is disposed between first light transmissive electrode layer 202 and second light transmissive electrode layer 207. Microcell layer 203 comprises a plurality of microcells (204) and a sealing layer (206). Each microcell of the plurality of microcells (204) includes an electrophoretic medium (209), the electrophoretic medium (209) comprising electrically charged pigment particles and a non-polar liquid (not shown). Each microcell of the plurality of microcells (204) has a microcell opening (205), the sealing layer (206) spanning the microcell openings (205) of the plurality of microcells (204). Each microcell of the plurality of microcells (204) comprises a microcell bottom layer (210), a channel (215), a protrusion structure (217), and microcell wall (212). The microcell bottom layer (210) has a microcell bottom inside surface (211), the microcell bottom inside surface (211) comprising an unexposed microcell bottom inside surface (211a), a first exposed microcell bottom inside surface (211b), and a second exposed microcell bottom inside surface (211c). The protrusion structure (217) has a protrusion structure solid part (217a), a well (217b), a protrusion structure solid part side surface (221), a protrusion base (218), a protrusion structure solid part side surface (221), a protrusion structure solid part inside surface (221b), a protrusion structure solid part outside surface (221a), a protrusion structure solid part apex (219), a protrusion apex surface, and a protrusion height (220). The well 217b has a three-dimensional shape having a volume, the whole volume of the well (217b) being filled by electrophoretic medium (209). The three-dimensional shape of the well is defined by a space between (i) the apex plane (229), (ii) the protrusion structure solid part inside surface (221a), and (iii) the second exposed microcell bottom inside surface (211c). The protrusion structure solid part side surface (221) is the surface of the protrusion structure solid part (217a) that is in contact with the electrophoretic medium.

The protrusion structure solid part outside surface (221a) is a part of the protrusion structure solid part side surface (221) that is not in contact with the one or more wells (217b). The protrusion structure solid part outside surface (221b) is the protrusion structure solid surface excluding the protrusion inside surface (221b). The protrusion apex (219) is a set of points of the protrusion structure (217), the set of points having shorter distance from the microcell opening (205) than all other points of the protrusion structure (217). The protrusion height (220) is the distance between the apex plane (229) and the protrusion base (218). The protrusion base (218) is a surface of the protrusion structure solid part and the surfaces of the one or more wells that are in contact with the microcell bottom layer (210).

The three-dimensional shape of the protrusion structure 217 (combination of protrusion structure solid part 217a and one or more wells 217b) of the variable light transmission device 500 of FIGS. 5A and 5B is a conical frustum on a cylinder. The conical frustum has a small base and a large base. The cylinder has a first base and a second base. The small base of the conical frustum is a part of the apex plane (229). The large base of the conical frustum is in contact with the first base of the cylinder, and the second base of the cylinder is in contact with the microcell bottom inside surface 211.

The three-dimensional shape of the protrusion structure 217 of the variable light transmission device 500 of FIGS. 5A and 5B may also be a polygonal pyramidal frustum on polygonal prism, the polygonal pyramidal frustum having from 3 to 20 sides, and the polygonal prism having a first base and a second base, both first and second bases having from 3 to 20 sides. The polygonal pyramidal frustum has a large base and a small base, both being polygons having from 3 to 20 sides. The small base of the conical frustum is part of the apex plane (229). The large base of the conical frustum is in contact with the first base of the polygonal prism. The second base of the polygonal prism is in contact with the microcell bottom inside surface 211.

The well 217b of variable transmission device 500 of FIGS. 5A and 5B may have a three-dimensional shape that is a conical frustum. The conical frustum has a large base and a small base. The large base of the conical frustum is part of the apex plane (229). The small base of the well 217b is in contact with the microcell bottom inside surface 211 (and part of the protrusion base). The well 217b of variable transmission device 500 of FIGS. 5A and 5B may also have a three-dimensional shape that is a polygonal pyramidal frustum.

Microcell wall 212 have microcell wall inside surface 213 and microcell wall upper surface 214. The microcell wall inside surface 213 is in contact with electrophoretic medium 209. The microcell wall upper surface 214 is the surface of microcell wall 212 of a microcell that is in contact with sealing layer 206.

The variable light transmission device that is illustrated in FIGS. 5A and 5B has a microcell with only one well. Multiple wells can be also included in a single microcell. A prospective view of a microcell of such variable light transmission device according to the second embodiment is illustrated in FIG. 5C. A microcell of this device comprises 22 wells. Analogous devices, having microcells with multiple well can be also manufactured for variable light transmission devices according to the first embodiment.

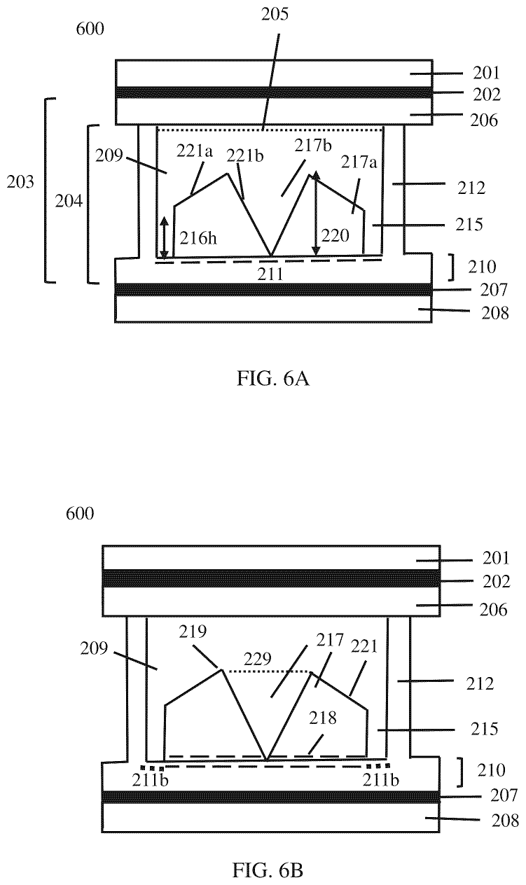

FIGS. 6A and 6B illustrate another example of a microcell of variable light transmission device 600 according to the second embodiment of the present invention. FIGS. 6A and 6B illustrate a cross-section (side view) of the same light transmission device. That is, the figure of FIG. 6A is repeated in FIG. 6B to facilitate the identification of the various parts and components of the device. These figures illustrate only a portion of the display (not in scale), showing only one microcell of the plurality of microcells of the device. Additional microcells are present in the microcell layer of the device.

Variable light transmission device 600 of FIGS. 6A and 6B has similar structure to the variable light transmission device 500 of FIGS. 5A and 5B. The only difference is in the three-dimensional shape of the well. The protrusion structure 217 of variable light transmission device 600 may be a conical frustum on a cylinder. The conical frustum has a small base and a large base. The cylinder has a first base and a second base. The small base of the conical frustum is part of the apex plane (229). The large base of the conical frustum is in contact with the first base of the cylinder. The second base of the cylinder is in contact with the microcell bottom inside surface 211.

The protrusion structure 217 of variable light transmission device 600 may be a polygonal pyramidal frustum on a polygonal prism. The polygonal pyramidal frustum has a small base and a large base. The polygonal prism has a first base and a second base. The small base of the polygonal pyramidal frustum is part of the apex plane (229). The large base of the polygonal pyramidal frustum is in contact with the first base of the polygonal prism. The second base of the polygonal prism is in contact with the microcell bottom inside surface 211.

The well 217b of variable transmission device 600 of FIGS. 6A and 6B may have a three-dimensional shape of a cone. The cone has a base and an apex. The base of the cone is part of the apex plane (229). The apex of the cone is in contact with the microcell bottom inside surface 211. The well 217b of variable transmission device 600 of FIGS. 6A and 6B may also have a three-dimensional shape of a polygonal pyramid.

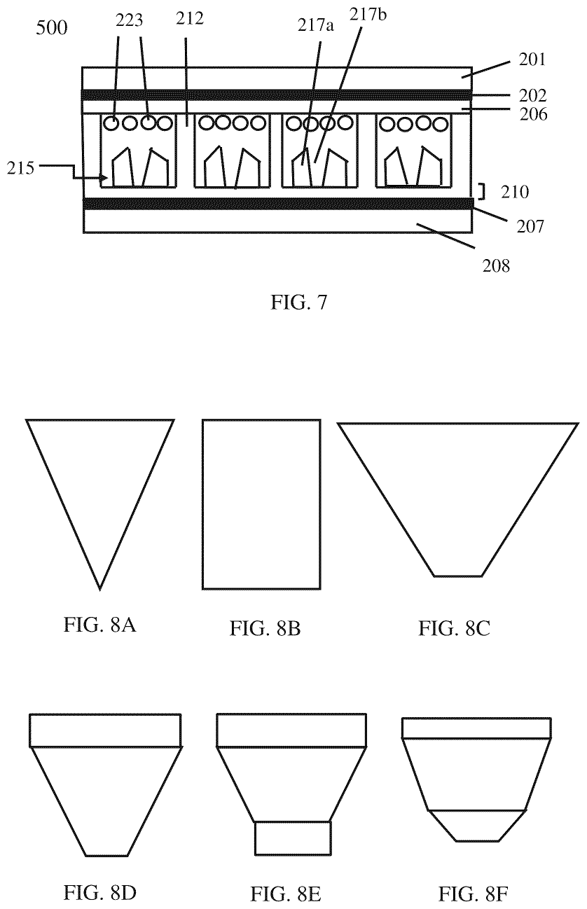

FIG. 7 illustrates a side view of a microcell of an example of a variable light transmission device of the second embodiment of the present invention. The variable light transmission device of FIG. 7 is the same as the variable light transmission device 500 of FIGS. 5A and 5B, but FIG. 7 shows a side view of a larger portion of the device, which comprises four microcells.

Variable light transmission devices of the second embodiment, examples of which are illustrated in FIGS. 5A, 5B, 6A, 6B, and 7, have microcells with both a channel and a well. Thus, the charged electrophoretic pigment particles can be collected in the well and the channel to form the open optical state of the device.

FIG. 8 illustrates examples of wells (side view). Specifically, FIG. 8A illustrates a side view of well that is a geometric solid of a cone or a polygonal pyramid, the polygonal pyramid having from 3 to 20 sides. FIG. 8B illustrates a side view of well that is a cylinder or a polygonal prism. FIG. 8C illustrates a side view of well that is a geometric solid of a conical frustum or a polygonal pyramidal frustum, the polygonal pyramidal frustum. FIG. 8D illustrates a side view of well that is a geometric solid of a cylinder on a conical frustum or a cylinder on a polygonal pyramidal frustum. FIG. 8E illustrates a side view of well that is a geometric solid of a cylinder on a conical frustum on a cylinder, or a cylinder on a polygonal pyramidal frustum on a cylinder. FIG. 8F illustrates a side view of well that is a geometric solid of a cylinder on a first conical frustum on a second conical frustum, or cylinder on a first polygonal pyramidal frustum on a second polygonal pyramidal frustum. The polygonal pyramidal frustum of the above geometric solids has bases with from 3 to 20 sides.

The variable light transmission device of the first embodiment and the second embodiment of the present invention may be switched from an open optical state (transparent state or light transmissive state) to a closed optical state (opaque state) by application of an electric field across the electrode layers.

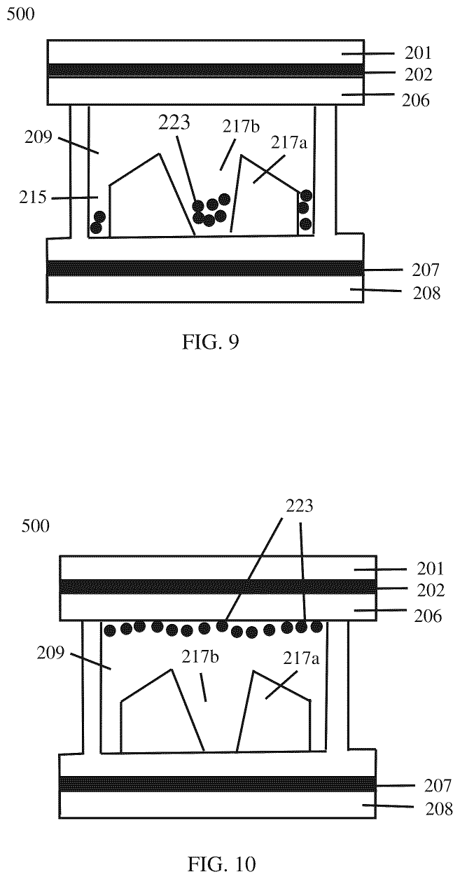

FIGS. 9 and 10 illustrate the switching to the optical states of variable light transmissive device 500 (of the second embodiment). When a first electric field is applied between the first light transmissive electrode layer 202 and the second light transmissive electrode layer 207 via a first waveform, movement of the electrically charged pigment particles 223 towards the well (217b) and the channel (215) is caused when the polarity of the electrically charged pigment particles 223 and the voltage polarity of the second light transmissive electrode layer are opposite to each other. If the polarity of the electrically charged pigment particles 223 and the voltage polarity of the second light transmissive electrode layer are opposite to each other, the electrically charged pigment particles 223 will be attracted by the second light transmissive electrode, and the variable light transmission device will switch to an open optical state, the open optical state having higher percent transparency than the closed optical state. The open optical state is illustrated in FIG. 9, where electrically charged pigment particles 223 are represented by black filled circles. In this example, the electrophoretic medium comprises one type of electrically charged pigment particles 223. In the open optical state, the electrically charged pigment particles 223 are present in the well of the microcell.

Application of a second electric field between the first light transmissive electrode layer 202 and the second light transmissive electrode layer 207 via a second waveform causes a movement of the electrically charged pigment particles 223 towards the first light transmissive electrode layer 202 with a velocity. This leads to the closed optical state, which is shown in FIG. 10. The velocity has a lateral component. In the absence of a lateral component of the velocity, the closed optical state will not take place, because the electrically charged pigment particles 223 will move from the well of the open optical state towards the first light transmissive electrode layer 202, but these electrically charged pigment particles 223 will occupy an area near the center of a microcell at the vicinity of the sealing layer 206. That is, electrically charged pigment particles 223 will not be spread across all of the surface of the first light transmissive electrode layer 202. Thus, the closed optical state will not be effectively formed, because the closed optical state will have relatively high light transmittance.

The above indicates that it is somewhat easier to achieve a transition from the closed optical state to the open optical state, because the slope of the protrusion structure will impart a lateral component to the velocity of the electrically charged pigment particles when they strike the protrusion surface of the protrusion structure during their movement towards second light transmissive electrode layer.

The variable light transmission device may be switched to an open optical state by applying a first electric field between the first light transmissive electrode layer and the second light transmissive electrode layer via a first waveform to cause movement of the electrically charged pigment particles towards the well (and the channel), resulting in the switching of the variable light transmission device to an open optical state. The variable light transmission device may be switched to an closed optical state by applying a second electric field between the first light transmissive electrode layer and the second light transmissive electrode layer via a second waveform to cause a movement of the first type of electrically charged pigment particles towards the first light transmissive electrode layer with a velocity, the velocity having a lateral component, and leading to a closed optical state, the second waveform comprising a series of at least two positive and negative pulses having a net positive or net negative impulse, wherein the closed optical state has lower percent transparency than the open optical state.

The second waveform may be DC-imbalanced. The second waveform may comprise at least one positive voltage and at least one negative voltage, the second waveform having a net positive or a net negative impulse. The choice of a net positive or net negative impulse depends on the polarity of the electrically charged pigment particles to be moved to the location of the electrophoretic medium near the sealing layer. Specifically, if the closed optical state involves movement of the electrically charged pigment particles that are negatively charged, a net positive impulse is required to move those particles from the well and the channel towards the first light transmissive electrode layer. In other words, this movement requires that the net result of the applied voltage be an attraction of the negatively charged particles by a positive voltage of the first light transmissive electrode layer in relation to the second light transmissive electrode layer. On the contrary, if the closed optical state involves movement of the electrically charged pigment particles that are positively charged, a net negative impulse is required to move the electrically charged pigment particles from the well and the channel near the second light transmissive electrode layer 207 towards the first light transmissive electrode layer.

A second electric field that is applied between the two light transmissive electrode layers via a second waveform achieves a closed optical state.

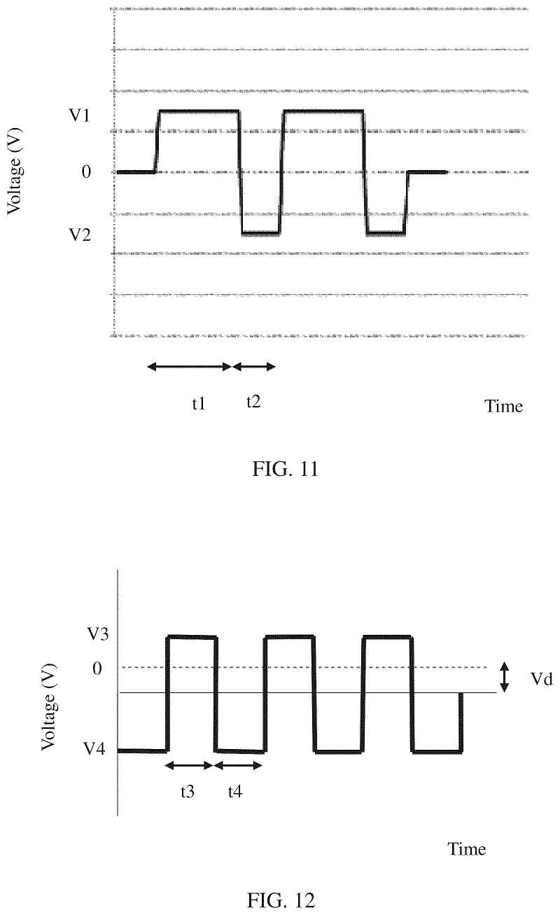

The second waveform may comprise an AC waveform, having a duty cycle different from 50%. An example of the second waveform is illustrated in FIG. 11.

The AC waveform may have a positive or negative DC bias. DC bias may be achieved by controlling the duty cycle of the waveform. The duty cycle for a positively DC biased waveform is higher than 50%. The duty cycle of a positively DC biased waveform may be higher than 55%, higher than 60%, or higher than 65%. The duty cycle for a positively DC biased waveform may be from 55% to 95%, from 58% to 90%, from 60% to 88%, from 65% to 85%, or from 70% to 80%. Analogously, the duty cycle for a negatively DC biased waveform is lower than 50%. The duty cycle for a negatively DC biased waveform may be lower than 45%, lower than 40%, or lower than 35%. The duty cycle for a negatively DC biased waveform may be from 5% to 45%, from 8% to 40%, from 10% to 38%, from 15% to 35%, or from 20% to 30%.

The waveform illustrated in the example of FIG. 11 comprises an AC square waveform having two or more cycles. Each cycle may comprise a first pulse of amplitude V1 applied for time period t1 and a second pulse of amplitude V2 applied for time period t2, wherein V1 is positive and V2 is negative, and wherein t1 is larger than t2. In the case that the amplitude of V1 is equal to the amplitude of V2 (|V1|=|V2|), a DC bias is achieved by the difference in the time periods. In the case of the example of FIG. 11, there is a positive DC bias, because the positive voltage V1 is applied for a longer time period (t1) than that of the negative voltage V2 (t2). Positive DC bias means that, if the electrically charged pigment particles of the variable light transmission device are negatively charged, the electrically charged pigment particles will move towards the first light transmissive electrode layer of the device. The duty cycle of the waveform can be calculated by Equation 4.

$$Duty Cycle = 100 \times ( V 1 \cdot t 1 ) / [ ( V 1 \cdot t 2 ) + ( V 2 \cdot t 2 ) ] \qquad Equation 4$$

In the waveform example of FIG. 11, the amplitude of V1 can be equal to the amplitude V2 (|V1|=|V2|), but, in general, the amplitudes V1 and V2 may be different from each other.

The example of the driving waveform of FIG. 11 is DC-imbalanced. However, one or more additional pulses may be included in the waveform of FIG. 11 of the opposite impulse, which can ensure that the overall waveform applied on a pixel is DC-balanced. This additional pulse (or additional pulses) may be applied before the DC-imbalanced waveform (pre-pulse). Also, the example of the waveform of FIG. 11 is a square AC waveform. Other examples of AC waveforms that can be used include sinusoidal waveforms, trigonal waveforms, and sawtooth waveforms.

The AC waveform may have an amplitude of from 10V to 200V and a frequency of from 0.1 to 6000 Hz. The AC waveform may have an amplitude of from 15V to 180V, from 20V to 160V, from 25V to 150V, or from 30V to 140V. The AC waveform may have a frequency of from 0.5 Hz to 5000 Hz, from 1 Hz to 4000 Hz, from 5 Hz to 3000 Hz, from 10 Hz to 2000 Hz, from 15 Hz to 1000 Hz, from 20 Hz to 800 Hz, or from 25 to 600 Hz. The ratio of the frequency of the AC waveform to the weight percent content of the charge control agent by weight of the electrophoretic medium may be from 400 Hz to 2000 Hz.

The second waveform may comprise a waveform that is formed by a superposition of a DC voltage component and an AC waveform. An example of the second waveform is illustrated in FIG. 12.

The waveform of FIG. 12 has a net negative impulse because of a DC offset (Ved). Although the period of time (t3) of the application of positive pulse is equal to the period of time (t4) of the application of negative pulse, a DC bias is achieved by the difference in the amplitudes of the pulses. Specifically, amplitude V3 of the positive pulse is smaller than amplitude V4 of the negative pulse. This is caused by the DC voltage component Vt of the waveform. That is, the waveform illustrated in FIG. 12 has a DC offset.

The example of the driving waveform of FIG. 12 is DC-imbalanced. However, one or more additional pulses may be included in the waveform of FIG. 12 of the opposite impulse, which can ensure that the overall waveform applied on a pixel is DC-balanced. This additional pulse (or additional pulses) may be applied before the DC-imbalanced waveform (pre-pulse). Also, the example of the waveform of FIG. 12 is a square AC waveform. Other examples of AC waveforms that may be used include a sinusoidal waveform, a trigonal waveform, and a sawtooth waveform.

The AC waveform may have an amplitude of from 10V to 200V and a frequency of from 0.1 to 6000 Hz. The AC waveform may have an amplitude of from 15V to 180V, from 20V to 160V, from 25V to 150V, or from 30V to 140V. The AC waveform may have a frequency of from 0.5 Hz to 5000 Hz, from 1 Hz to 4000 Hz, from 5 Hz to 3000 Hz, from 10 Hz to 2000 Hz, from 15 Hz to 1000 Hz, from 20 Hz to 800 Hz, or from 25 to 600 Hz. The ratio of the frequency of the AC waveform to the weight percent content of the charge control agent by weight of the electrophoretic medium may be from 400 Hz to 2000 Hz.

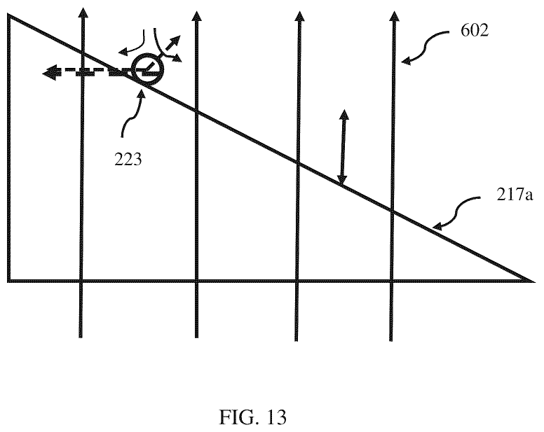

In a case when the ICEO-induced motion of the electrically charged pigment particles is relatively low, the protrusion structure solid part (217a) of the microcell contributes to an effective operation of the variable light transmission device, even if the device is driven using a DC-balanced AC waveform. In the example of the protrusion structure comprising a well having a surface with a slope, any electrically charged pigment particles that are located at the surface will experience a net force that will move them upwards, as shown in FIG. 13. FIG. 13 shows electrically charged pigment particle 223 in contact with well in an electric field 602. In this case, the ICEO flows are illustrated by the curved arrows, being more constrained on the “uphill” side of the cone than the “downhill” side. This imparts a force to the particle shown by the dotted horizontal arrow. There will be an opposing force perpendicular to the cone, forcing the particle upwards. With an appropriate choice of AC fields and frequencies, the particles can be moved out of the well. The same concept is relevant to particles that are located in a channel, if the geometry of the channel comprises a surface having a similar slope.

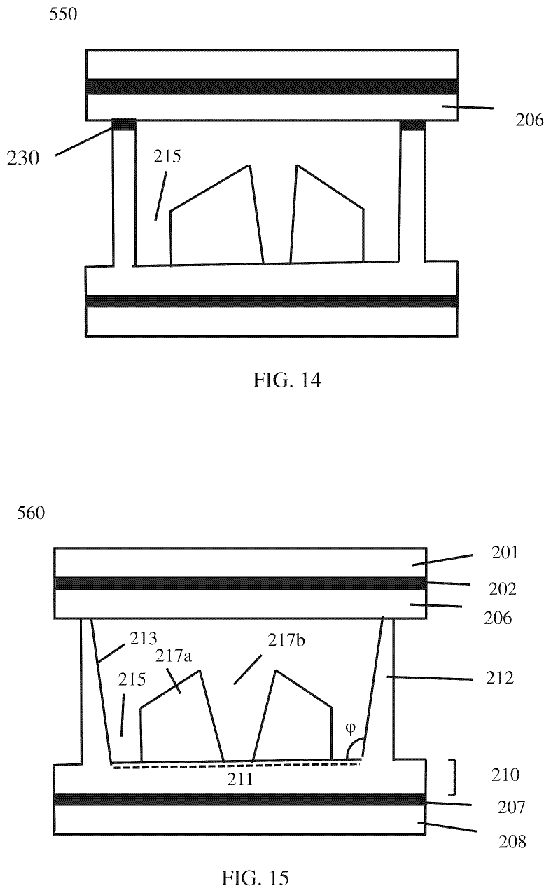

The microcells of the variable light transmission device of the present invention (550) may also comprise a light blocking layer 230, as shown in FIG. 14. Light blocking layer 230 is disposed between the microcell upper surface and sealing layer 206. Light blocking layer 230 may comprise a light absorbing pigment. The light absorbing pigment of the light blocking layer may have black color. The inventors of the present invention found that light blocking layer 230 contributes to an improved closed optical state by increasing the opacity of the device that may be caused by a partially light transmissive wall material. Light blocking layer 230 may be electrically conductive, which may facilitate the switching of the device.

FIG. 15 also illustrates a variable light transmission device of the present invention (560) comprising light transmissive substrate 201, first light transmissive electrode layer 202, microcell layer comprising a plurality of microcells and a sealing layer 206 (herein only one microcell of the plurality of microcells is shown), second light transmissive layer 207, and second light transmissive substrate 208. The microcell comprises microcell wall 212, channel 215, protrusion structure solid part 217a, well 217b, and microcell bottom 210. In the microcell of the variable light transmission device of FIG. 15, the microcell inside wall surface (213) forms an angle (φ) with microcell bottom inside surface (211), the angle being larger than 90 degrees. The inventors of the present invention found that such a structure significantly facilitates the embossing process for the making of the plurality of microcells, by enabling smooth removal of the embossing tool that does not damage the microcell wall. Angle φ may be from 90 to 120 degrees, 93 to 117 degrees, 95 to 115 degrees, 98 to 118 degrees, or 100 to 115 degrees.

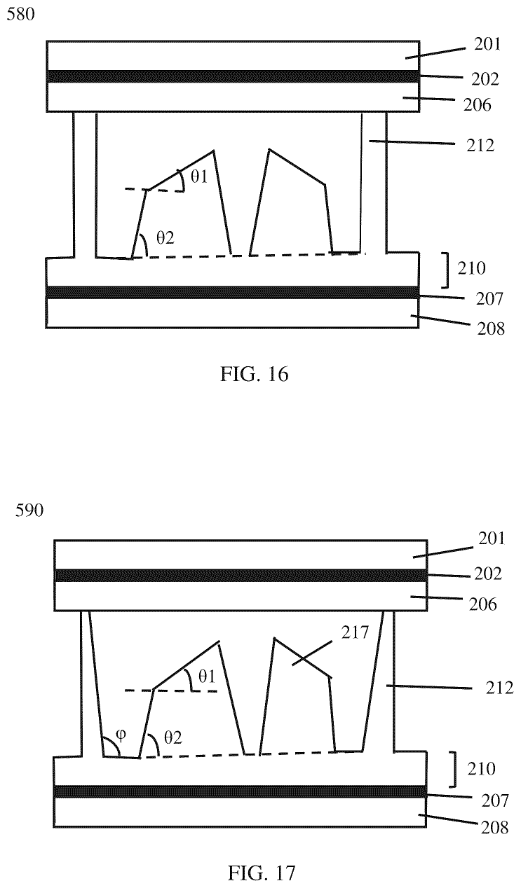

An element that facilitates the process of making the device is shown in FIG. 16, which illustrates a variable light transmission device (580) of the present invention. The device comprises light transmissive substrate 201, first light transmissive electrode layer 202, microcell layer comprising a plurality of microcells and a sealing layer 206 (herein only one microcell of the plurality of microcells is shown), second light transmissive layer 207, and second light transmissive substrate 208. The microcell comprises microcell wall 212, protrusion structure 217, and microcell bottom 210. The protrusion structure 217 is a geometric solid of a first conical frustum on a second conical frustum. The first conical frustum has a first slope (θ1), and the second conical frustum has a second slope (θ2). The second slope (θ2) is larger than the first slope (θ1), and the difference between the second slope (θ2) and the first slope (θ1) is from 1 to 25 degrees, from 1 to 30 degrees, from 2 to 20 degrees, from 2 to 15 degrees, from 2 to 12 degrees, from 2 to 9 degrees, from 2 to 8 degrees, from 3 to 8 degrees, or from 4 to 8 degrees.

FIG. 17 illustrates another variable light transmission device (590) of the present invention, which enables an even easier process of making the device. The variable light transmission device comprises light transmissive substrate 201, first light transmissive electrode layer 202, microcell layer comprising a plurality of microcells and a sealing layer 206 (herein only one microcell of the plurality of microcells is shown), second light transmissive layer 207, and second light transmissive substrate 208. The microcell comprises microcell wall 212, protrusion structure 217, and microcell bottom 210. The protrusion structure has a similar structure as this of FIG. 16 with the slope of the second conical frustum θ2 (second slope) being larger than the slope θ1 (first slope) of the first conical frustum. The difference between the second slope (θ2) and the first slope (θ1) is from 1 to 25 degrees, from 1 to 30 degrees, from 2 to 20 degrees, from 2 to 15 degrees, from 2 to 12 degrees, from 2 to 9 degrees, from 2 to 8 degrees, from 3 to 8 degrees, or from 4 to 8 degrees. Furthermore, in the device of FIG. 17, the microcell inside wall surface (213) forms an angle (φ) with microcell bottom inside surface (211), the angle being larger than 90 degrees. Angle φ may be from 90 to 120 degrees, 93 to 117 degrees, 95 to 115 degrees, 98 to 118 degrees, or 100 to 115 degrees.

One problem encountered in open optical states of variable light transmission devices, where light-absorbing electrically charged pigment particles are located in only a portion of each microcell (such as in channels), is diffraction patterns that are observable within the field of vision. Such diffraction patterns, known as Fraunhofer diffraction patterns, can be disturbing to a viewer and are formed when light from a small object such as a light source in a dark ambient environment or when light from specular reflections of the sun in a bright ambient environment passes through the variable light transmission device in the open optical state.

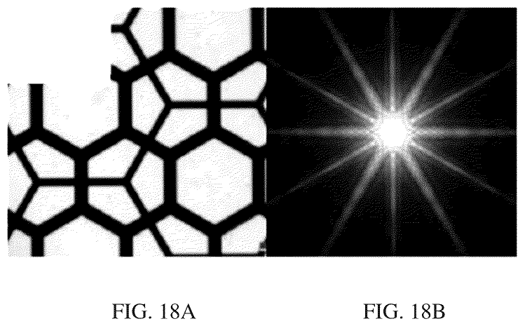

In FIG. 18A, the diffraction pattern formed by a hexagon aperture is shown. The diffraction pattern of FIG. 18B includes highly visible linear components with decreasing light intensity as the linear component is further from the center of the light pattern. The diffraction pattern is formed by a variable light transmission device (shown in FIG. 18A) having microcells with conical protrusion structure solid part and hexagonal channel, the protrusion structure of the variable light transmission device having no wells.

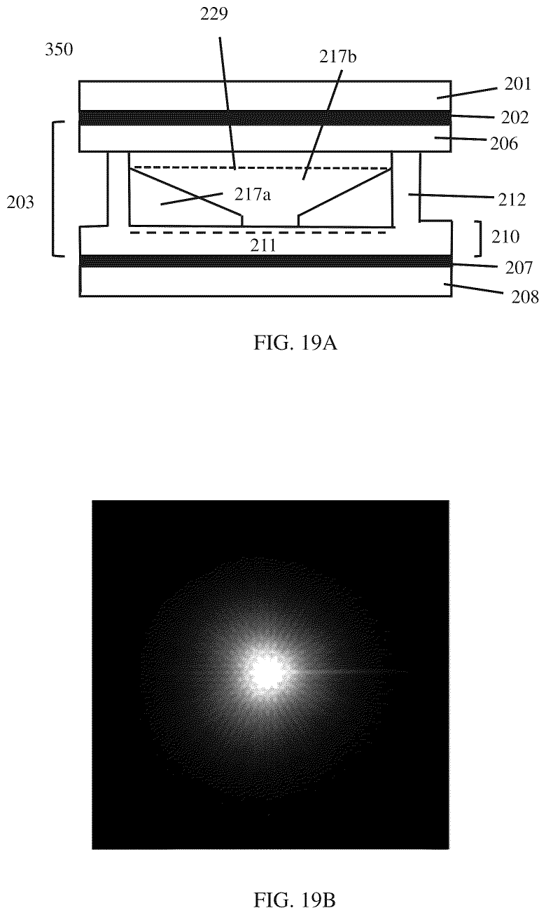

In contrast, FIG. 19B shows the diffraction pattern formed by the variable light transmission device 350, which is illustrated in FIG. 19A. Variable light transmission device 350 comprises, in order, first light transmissive substrate 201, first light-transmissive electrode layer 202, microcell layer 203, second light-transmissive electrode layer 207, and second light transmissive substrate 208. Microcell layer 203 comprises a plurality of microcells and a sealing layer 206. Each microcell of the plurality of microcells comprises microcell bottom layer 210, protrusion structure, and microcell wall 212. The protrusion structure comprises protrusion structure solid part 217a and well 217b. The protrusion structure has an apex plane 229. The protrusion structure of variable light transmission device 350 of FIG. 19A is a cylinder having a first base and a second base, the first base being part of the apex plane 229, and the second base being in contact with the microcell bottom inside surface 211. Well 217b of variable light transmission device 350 is a conical frustum on a cylinder. The conical frustum has a large base and a small base, and the cylinder has a first base and a second base. The large base of the conical frustum is part of the apex plane 229. The small base of the conical frustum is in contact with the first base of the cylinder of the well. The second base of the well is in contact with the microcell bottom inside surface 211. The diffraction pattern from variable light transmission device 350 of FIG. 19A does not have highly visible linear components as the diffraction pattern from of variable light transmission device of FIG. 19B.

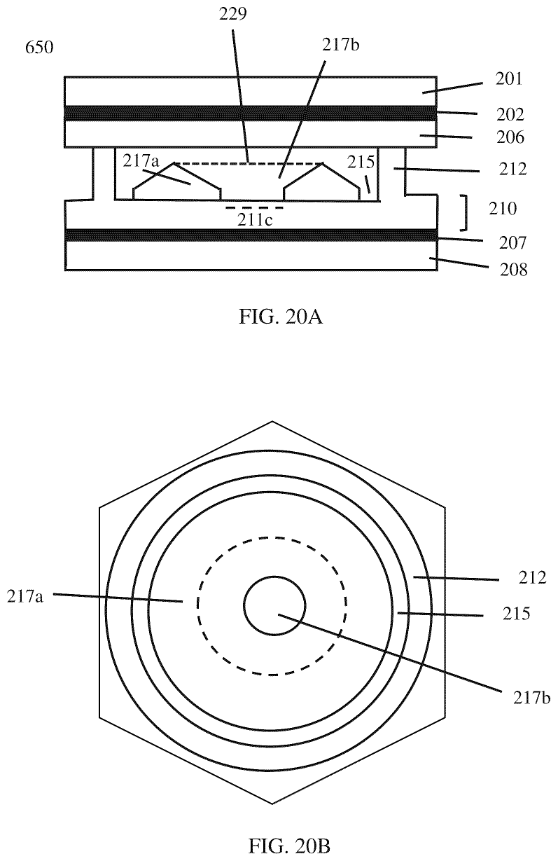

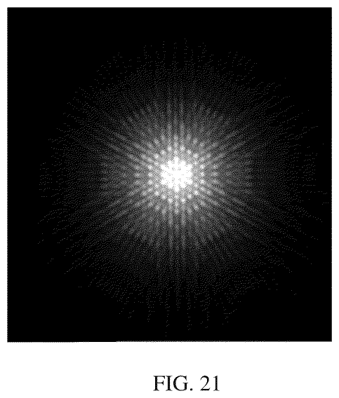

FIG. 21 shows the diffraction pattern formed by the variable light transmission device 650, which is illustrated in FIGS. 20A and 20B. FIG. 20A is a side view of a portion of variable light transmission device 650 and FIG. 20B is a top view of a portion of variable light transmission device 650. Variable light transmission device 650 comprises, in order, first light transmissive substrate 201, first light-transmissive electrode layer 202, microcell layer 203, second light-transmissive electrode layer 207, and second light transmissive substrate 208. Microcell layer 203 comprises a plurality of microcells and a sealing layer 206. Each microcell of the plurality of microcells comprises microcell bottom layer 210, a protrusion structure, channel 215 and a microcell wall 212. The protrusion structure comprises protrusion structure solid part 217a and well 217b. The protrusion structure has an apex plane 229. The protrusion structure of variable light transmission device 650 of FIG. 20A and 20B is a conical frustum on a cylinder.

Thus, the variable light transmission device of the first and second embodiments of the present invention provides improvements in in the optical performance of the open optical state.

### Clauses

Clause 1: A variable light transmission device (200) comprising: a first light transmissive electrode layer (202), a second light transmissive electrode layer (207) and a microcell layer (203), the microcell layer (203) being disposed between the first light transmissive electrode layer (202) and the second light transmissive electrode layer (207), the microcell layer (203) comprising a plurality of microcells (204) and a sealing layer (206), each microcell of the plurality of microcells (204) including an electrophoretic medium (209), the electrophoretic medium (209) comprising electrically charged pigment particles and a non-polar liquid, each microcell of the plurality of microcells (204) having a microcell opening (205), the sealing layer (206) spanning the microcell openings (205) of the plurality of microcells (204);
   the sealing layer (206) of each microcell having an upper surface and a lower surface, the lower surface being in contact with the electrophoretic medium (209), the upper surface being in contact (i) with the first light transmissive electrode layer (202) or (ii) with an adhesive layer, the adhesive layer being disposed between the first light transmissive electrode layer (202) and the upper surface of the sealing layer (206);
   each microcell of the plurality of microcells (204) comprising a microcell bottom layer (210), a protrusion structure (217), and a microcell wall (212), the microcell bottom layer (210) having a microcell bottom inside surface (211);
   the protrusion structure (217) consisting of a protrusion structure solid part (217a), one or more wells (217b), the protrusion structure (217) having a protrusion base (218), an apex plane (229), and a protrusion height (220), the protrusion structure solid part (217a) having a protrusion structure solid part apex (219), a protrusion structure solid part side surface (221), and a protrusion structure solid part base (218a), the protrusion solid part apex (219) being a point or a set of points of the protrusion structure solid part (217a) having shorter distance from the microcell opening (205) than all other points of the protrusion structure solid part (217a), the apex plane (229) being a plane that is parallel to the plane of the microcell opening (205) and containing the protrusion structure solid part apex (219), the protrusion structure solid part side surface (221) being a surface of the protrusion structure solid part (217a) that is in contact with the electrophoretic medium (209) not including the protrusion structure solid part apex (219), the protrusion structure solid part base (218a) being a surface of the protrusion structure solid part (217a) that is in contact with the microcell bottom inside surface (211), the protrusion base (218) being a surface of the protrusion structure solid part and the surfaces of the one or more wells that are in contact with the microcell bottom layer (210), the protrusion height (220) being the distance between the apex plane (229) and the protrusion base (218), the protrusion structure (217) having a three-dimensional shape, the three-dimensional shape of the protrusion structure being a cylinder or a polygonal prism, the polygonal prism having a first base and a second base, the first base and the second base having each from 3 to 20 sides;
   the one or more wells (217b) having a volume that is filled with electrophoretic medium (209), each of the one or more wells (217b) having a three-dimensional shape consisting of one geometric solid or a combination of two or more geometric solids, the three-dimensional shape of each of the one or more wells (217b) being defined by a space between (i) the apex plane (229), (ii) the protrusion structure solid part side surface (221), and (iii) the microcell bottom inside surface (211), the one geometric solid and each of the two or more geometric solids of the three-dimensional shape of each of the one or more wells being selected from the group consisting of a cone, a conical frustum, a cylinder, a conical frustum, a polygonal pyramid, a polygonal pyramidal frustum, and a polygonal prism, the cone having a base and an apex, the conical frustum having a large base and a small base, the cylinder having a first base and a second base, the polygonal pyramid having a base and an apex, the base of the polygonal pyramid being a polygon with 3-20 sides, the polygonal pyramidal frustum having a large base and a small base, the large base and the small base of the polygonal pyramidal frustum being a polygon with 3-20 sides, and the polygonal prism having a first base and a second base, the first base and the second base of the polygonal prism being a polygon with 3-20 sides;
   the microcell wall (212) having a microcell inside wall surface (213) and a microcell wall upper surface (214), the microcell inside wall surface (213) being a surface of the microcell wall (212) of a microcell that is in contact with the electrophoretic medium (209), the microcell wall upper surface (214) being a surface of the microcell wall (212) of a microcell that is in contact with the sealing layer (206);
   the variable light transmission device having a first outer surface (250) and a second outside surface (251), the first outside surface (250) being located on a side of the variable light transmission device that is near the first light transmissive electrode layer (202), and the second outside surface (251) being located on a side of the variable light transmission device that is near the second light transmissive electrode layer (207);
   wherein application of a first electric field between the first light transmissive electrode layer (202) and the second light transmissive electrode layer (207) via a first waveform causes movement of the electrically charged pigment particles towards the one or more wells (217b), resulting in switching of the variable light transmission device to an open optical state;
   wherein application of a second electric field between the first light transmissive electrode layer (202) and the second light transmissive electrode layer (207) via a second waveform causes a movement of the electrically charged pigment particles towards the first light transmissive electrode layer (202), wherein the closed optical state has lower percent transparency than the open optical state.
Clause 2: A variable light transmission device (300) comprising:
   a first light transmissive electrode layer (202);
   a second light transmissive electrode layer (207); and a microcell layer (203), the microcell layer (203) being disposed between the first light transmissive electrode layer (202) and the second light transmissive electrode layer (207), the microcell layer (203) comprising a plurality of microcells (204) and a sealing layer (206), each microcell of the plurality of microcells (204) including an electrophoretic medium (209), the electrophoretic medium (209) comprising electrically charged pigment particles and a non-polar liquid, each microcell of the plurality of microcells (204) having a microcell opening (205), the sealing layer (206) spanning the microcell openings (205) of the plurality of microcells (204);
   the sealing layer (206) of each microcell having an upper surface and a lower surface, the lower surface being in contact with the electrophoretic medium (209), the upper surface being in contact (i) with the first light transmissive electrode layer (202) or (ii) with an adhesive layer, the adhesive layer being disposed between the first light transmissive electrode layer (202) and the upper surface of the sealing layer (206);
   each microcell of the plurality of microcells (204) comprising a microcell bottom layer (210), a channel (215), a protrusion structure (217), and a microcell wall (212), the microcell bottom layer (210) having a microcell bottom inside surface (211);
   the microcell wall (212) having a microcell inside wall surface (213) and a microcell wall upper surface (214), the microcell inside wall surface (213) being a surface of the microcell wall (212) that is in contact with the electrophoretic medium (209), the microcell wall upper surface (214) being a surface of the microcell wall (212) that is in contact with the sealing layer (206);
   the protrusion structure (217) consisting of a protrusion structure solid part (217a) and one or more wells (217b), the protrusion structure (217) having a protrusion base (218), an apex plane (229), and a protrusion height (220), the protrusion structure solid part (217a) having a protrusion structure solid part apex (219), a protrusion structure solid part side surface (221), and a protrusion structure solid part base (218a), the protrusion solid part apex (219) being a point or a set of points of the protrusion structure solid part (217a) having shorter distance from the microcell opening (205) than all other points of the protrusion structure solid part (217a), the apex plane (229) being a plane that is parallel to the plane of the microcell opening (205) and containing the protrusion structure solid part apex (219), the protrusion structure solid part side surface (221) being a surface of the protrusion structure solid part (217a) that is in contact with the electrophoretic medium (209) not including the protrusion structure solid part apex (219), the protrusion structure solid part base (218a) being a surface of the protrusion structure solid part (217a) that is in contact with the microcell bottom inside surface (211), the protrusion base (218) being a surface of the protrusion structure solid part and the surfaces of the one or more wells that are in contact with the microcell bottom layer (210), the protrusion height (220) being the distance between the apex plane (229) and the protrusion base (218);
   the protrusion structure having a three-dimensional shape, the three-dimensional shape of the protrusion structure consisting of one geometric solid or a combination of two or more geometric solids, the one geometric solid and each of the two or more geometric solids of the three-dimensional shape of the protrusion structure being selected from the group consisting of a cylinder, a polygonal prism, a conical frustum, and a polygonal pyramidal frustum, the cylinder having a first base and a second base, the polygonal prism having a first base and a second base, the first base and the second base of the polygonal prism being a polygon with 3-20 sides, the conical frustum having a large base and a small base, the polygonal pyramidal frustum having a large base and a small base, the large base and the small base of the polygonal pyramidal frustum being a polygon with 3-20 sides;
   the protrusion structure solid part side surface (221) consisting a protrusion structure solid part inside surface (221b) and a protrusion structure solid part outside surface (221a), the protrusion structure solid part inside surface (221b) being a part of the protrusion structure solid part side surface (221) that is in contact with the one or more wells (217b), the protrusion structure solid part outside surface (221a) being a part of the protrusion structure solid part side surface (221) that is not in contact with the one or more wells (217b);
   the microcell bottom inside surface (211) consisting of an unexposed microcell bottom inside surface (211a), a first exposed microcell bottom inside surface (211b), and a second exposed bottom inside surface (211c), the unexposed microcell bottom inside surface (211a) being in contact with the protrusion structure solid part base (218a) and not in contact with the electrophoretic medium (209), the first exposed microcell bottom inside surface (211b) and the second exposed bottom inside surface (211c) being in contact with the electrophoretic medium (209), the first exposed microcell bottom inside surface (211c) being in contact with the channel (215), and the second exposed microcell bottom inside surface (211b) being in contact with the one or more wells (217b);
   the channel (215) having a channel height (216h), an inner base perimeter (225), and an outer base perimeter (226), the channel (215) having a volume that is filled with electrophoretic medium (209), the channel being a three-dimensional shape that is defined by the protrusion structure solid part outside surface (221a), the first exposed microcell bottom inside surface (211b), the microcell inside wall surface (213), and a plane that is parallel to the first exposed microcell bottom inside surface (211b), the plane having a distance from first exposed microcell bottom inside surface (211b) equal to the channel height (216h), the channel height (216h) being 50% of the protrusion height (220), the inner base perimeter (225) being an intersection of the microcell wall (212) and the first exposed microcell bottom inside surface (211b), the outer base perimeter (226) being an intersection of the protrusion structure solid part outside surface (221a) and the first exposed microcell bottom inside surface (211b);
   each of the one or more wells (217b) having a volume that is filled with electrophoretic medium (209), each of the one or more wells (217b) having a three-dimensional shape consisting of one geometric solid or a combination of two or more geometric solids, the three-dimensional shape of each of the one or more wells (217b) being defined by a space between (i) the apex plane (229), (ii) the protrusion structure solid part inside surface (221b), and (iii) the second exposed microcell bottom inside surface (211c), the one geometric solid and each of the two or more geometric solids of the three-dimensional shape of each of the one or more wells being selected from the group consisting of a cone, a conical frustum, a cylinder, a conical frustum, a polygonal pyramid, a polygonal pyramidal frustum, and a polygonal prism, the cone having a base and an apex, the conical frustum having a large base and a small base, the cylinder having a first base and a second base, the polygonal pyramid having a base and an apex, the base of the polygonal pyramid being a polygon with 3-20 sides, the polygonal pyramidal frustum having a large base and a small base, the large base and the small base of the polygonal pyramidal frustum being a polygon with 3-20 sides, and the polygonal prism having a first base and a second base, the first base and the second base of the polygonal prism being a polygon with 3-20 sides;
   the variable light transmission device having a first outer surface (250) and a second outside surface (251), the first outside surface (250) being located on a side of the variable light transmission device that is near the first light transmissive electrode layer (202), and the second outside surface (251) being located on a side of the variable light transmission device that is near the second light transmissive electrode layer (207);
   wherein application of a first electric field between the first light transmissive electrode layer (202) and the second light transmissive electrode layer (207) via a first waveform causes movement of the electrically charged pigment particles towards the one or more wells (217b) and the channel, resulting in switching of the variable light transmission device to an open optical state;
   wherein application of a second electric field between the first light transmissive electrode layer (202) and the second light transmissive electrode layer (207) via a second waveform causes a movement of the electrically charged pigment particles towards the first light transmissive electrode layer (202), wherein the closed optical state has lower percent transparency than the open optical state.
Clause 3: The variable light transmission device (200, 300) according to clause 1 or clause 2, wherein the three-dimensional shape of each of the one or more wells are selected from the group consisting of (a) a cone or a polygonal pyramid, the base of the cone or polygonal pyramid being in contact with the apex plane (229) and the apex of the cone or polygonal pyramid being in contact with the microcell bottom inside surface (211); (b) a cylinder, a conical frustum, a polygonal pyramidal frustum, or a polygonal prism, the first base of the cylinder, the large base of the conical frustum, the large base of the polygonal pyramidal frustum, or the first base of the pyramidal prism being in contact with the apex plane (229) and the second base of the cylinder, the small base of the conical frustum, the small base of the polygonal pyramidal frustum, and the second base of the polygonal prism being in contact with the microcell bottom inside surface; (c) a cylinder or a first conical frustum on a cone or a second conical frustum, the first base of the cylinder being in contact with the apex plane (229), the second base of the cylinder being in contact with the base of the cone or the large base of the conical frustum, and the apex of the cone or the small base of the conical frustum being in contact with the microcell bottom inside surface; (d) a polygonal prism or a first polygonal pyramidal frustum on a polygonal pyramid or a second polygonal pyramidal frustum, the first base of the polygonal prism or the large base of the first polygonal pyramidal frustum being in contact with the apex plane (229), the second base of the polygonal prism or the small base of the first polygonal pyramidal frustum being in contact with the base of the polygonal pyramid or the large base of the large polygonal pyramidal frustum, and the apex of the polygonal pyramid or the small base of the second polygonal pyramidal frustum being in contact with the microcell bottom inside surface, wherein the first and second bases of the polygonal prism, the large and small bases of the first polygonal pyramidal frustum, the base of the polygonal pyramid, and the large and small bases of the second polygonal pyramidal frustum have the same number of sides; (e) a first polygonal pyramidal frustum on a polygonal pyramid or a second polygonal pyramidal frustum or a polygonal prism, the large base of the first polygonal pyramid being in contact with the apex plane (229), the small base of the first polygonal pyramidal frustum being in contact with the base of the polygonal pyramid or the large base of the second polygonal pyramidal frustum or the first base of the polygonal prism, and the apex of the polygonal pyramid or the small base of the second polygonal pyramidal frustum being or the second base of the polygonal prism in contact with the microcell bottom inside surface, wherein the first and second bases of the first polygonal pyramidal frustum, the large and small bases of the second polygonal pyramidal frustum, the base of the polygonal pyramid, and the first and second bases of the polygonal prism have the same number of sides; (f) a first conical frustum on a cone or a second conical frustum or a cylinder, the large base of the first conical frustum being in contact with the apex plane (229), the small base of the first conical frustum being in contact with the base of the cone or large base of the second conical frustum or first base of the cylinder, and the apex of the cone or the small base of the second conical frustum or the second base of the cylinder being in contact with the microcell bottom inside surface; (g) a first cylinder on a first conical frustum on a cone or second conical frustum or second cylinder, the first base of the first cylinder being in contact with the apex plane (229), the second base of the first cylinder being in contact with the large base of the first conical frustum, the small base of the first conical frustum being in contact with the base of the cone or the large base of the second conical frustum or the first base of the second cylinder, and the apex of the cone or the small base of the second conical frustum or the second base of the second cylinder being in contact with the microcell bottom inside surface; (h) a first conical frustum on a cylinder or second conical frustum on a cone or third conical frustum, the large base of the first conical frustum being in contact with the apex plane (229), the small base of the first conical frustum being in contact with the first base of the cylinder or the large base of the second conical frustum, the second base of the cylinder or the small base of the second conical frustum being in contact with the base of the cone or the large base of the third conical frustum, and the apex of the cone or the small base of the third conical frustum being in contact with the microcell bottom inside surface; (i) a first conical frustum on a second conical frustum on a cone or third conical frustum or a cylinder, the large base of the first conical frustum being in contact with the apex plane (229), the small base of the first conical frustum being in contact with the large base of the second conical frustum, the small base of the second conical frustum being in contact with the base of the cone or the large base of the third conical frustum or the first base of the cylinder, and the apex of the cone or the small base of the third conical frustum or the second base of the cylinder being in contact with the microcell bottom inside surface; (j) a first polygonal pyramidal frustum on a pyramidal prism or second polygonal pyramidal frustum on a polygonal pyramid or third polygonal pyramidal frustum, the large base of the first polygonal pyramidal frustum being in contact with the apex plane (229), the small base of the first polygonal pyramidal frustum being in contact with the first base of the pyramidal prism or the large base of the second polygonal pyramidal frustum, the second base of the pyramidal prism or the small base of the second polygonal pyramidal frustum being in contact with the base of the polygonal pyramid or the large base of the third polygonal pyramidal frustum, and the apex of the pyramidal prism or the small base of the third polygonal pyramidal frustum being in contact with the microcell bottom inside surface, wherein the large and small bases of the first polygonal pyramidal frustum, the first and second bases of the pyramidal prism, the large and small bases of the second polygonal pyramidal frustum, the base of the polygonal pyramid, and the large and small bases of the third polygonal pyramidal frustum have the same number of sides; and (k) a first polygonal pyramidal frustum on a second polygonal pyramidal frustum on a polygonal pyramid or third polygonal pyramidal frustum or a polygonal prism, the large base of the first polygonal pyramidal frustum being in contact with the apex plane (229), the small base of the first polygonal pyramidal frustum being in contact with the large base of the second polygonal pyramidal frustum, the small base of the second polygonal pyramidal frustum being in contact with the base of the cone or the large base of the third conical frustum or the first base of the cylinder, and the apex of the polygonal pyramid or the small base of the third polygonal pyramidal frustum or the second base of the polygonal prism in contact with the microcell bottom inside surface, wherein the large and small bases of the first, second, and third polygonal pyramidal frustum, the first and second bases of the pyramidal prism, and the base of the polygonal pyramid have the same number of sides.
Clause 4: The variable light transmission device (200, 300) according to any one or clause 1 to clause 3, wherein the three-dimensional shape of the protrusion structure (217) is selected from the group consisting of (a) a cylinder, the first base of the cylinder being the protrusion base (218) and the second base of the cylinder being in contact with the apex plane (229); (b) a polygonal prism, the first base of the polygonal prism being the protrusion base (218) and the second base of the polygonal prism being in contact with the apex plane (229), the first base and the second base having each from 3 to 20 sides; (c) a conical frustum, the large base of the conical frustum being the protrusion base (218) and the small base of the conical frustum being in contact with the apex plane (229); (d) a polygonal pyramidal frustum, the large base of the polygonal pyramidal frustum being the protrusion base (218), the small base of the polygonal pyramidal frustum being in contact with the apex plane (229), the large base and the small base of the polygonal pyramidal frustum each having the same number of sides, the number of sides being from 3 to 20 sides; (e) a first conical frustum on a cylinder or a second conical frustum, the first base of the cylinder or the large base of the second conical frustum being the protrusion base (218), the second base of the cylinder or the small base of the second conical frustum being in contact with the large base of the first conical frustum, the small base of the first conical frustum being in contact with the apex plane (229); and (f) a first polygonal pyramidal frustum on an polygonal prism or a second polygonal pyramidal frustum, the first base of the polygonal prism or the large base of the second pyramidal frustum being the protrusion base (218), the second base of the polygonal prism or the small base of the second pyramidal frustum being in contact with the large base of the first polygonal pyramidal frustum, and the small base of the first polygonal pyramidal frustum being in contact with the apex plane (229), wherein the large and small base of the first and second polygonal pyramidal frustum and the first and second bases of the pyramidal prism each have the same number of sides, the number of sides being from 3 to 20 sides.
Clause 5: The variable light transmission device of clause 1, wherein the microcell opening (205) of each microcell of the plurality of microcells (204) of the microcell layer (203) has a shape, the shape of the microcell opening (205) being selected from the group consisting of a circle, an ellipse, a square, a rectangle, and a polygon, the polygon having 5 to 12 sides.
Clause 6: The variable light transmission device according to any one of clause 1 to clause 5, wherein each microcell of the plurality of microcells (204) has a length of from 400 micrometers to 800 micrometers and a height of from 20 micrometers to 100 micrometers
Clause 7: The variable light transmission device according to according to any one of clause 2 to clause 6, wherein the channel (215) has a width of from 10 micrometers to 30 micrometers.
Clause 8: The variable light transmission device according to any one of clause 2 to clause 7, wherein the variable light transmission device comprises a microcell the inside wall surface (213) and the first exposed microcell bottom surface (211b) of which form an angle (φ) of from 90 to 120 degrees.
Clause 9: The variable light transmission device according to any one of clause 1 to clause 8, wherein the variable light transmission device comprises (i) an adhesive layer, the adhesive layer being disposed between the first light transmissive electrode layer (202) and the sealing layer (206), (ii) a second adhesive layer, the second adhesive layer being disposed between the microcell layer (203) and the second light transmissive electrode layer (207), or (iii) both the adhesive layer and the second adhesive layer.
Clause 10: The variable light transmission device according to any one of clause 1 to clause 9, wherein the variable light transmission device comprises a light blocking layer (230) disposed between the microcell wall upper surface (214) and the sealing layer (206), the light blocking layer (230) comprising light absorbing pigment.
Clause 11: The variable light transmission device of clause 10, wherein the light absorbing pigment of the light blocking layer (230) has black color.
Clause 12: The variable light transmission device according to any one of clause 1 to clause 11, wherein the electrically charged pigment particles (223) of the electrophoretic medium (209) are light absorbing.
Clause 13: The variable light transmission device according to any one of clause 1 to clause 12, wherein the second electric field causes a movement of the electrically charged pigment particles (223) towards the first light transmissive electrode layer (202) with a velocity, the velocity having a lateral component.
Clause 14: The variable light transmission device according to any one of clause 1 to clause 13, wherein the second waveform comprises at least one positive voltage and at least one negative voltage, the second waveform having a net positive or net negative impulse.
Clause 15: The variable light transmission device of clause 14, wherein the second waveform comprises an AC waveform, the AC waveform having a duty cycle of from 5% to 45%, or wherein the second waveform comprises a DC-offset waveform, which is formed by a superposition of a DC voltage component and an AC waveform.
Clause 16: The variable light transmission device according to any one of clause 1 to clause 15, wherein the variable light transmission device comprises a microcell having a protrusion structure comprising from 10 to 39 wells.
Clause 17: The variable light transmission device according to any one of clause 2 to clause 15, wherein the variable light transmission device comprises a microcell having a protrusion structure comprising from 1 to 3 wells.
Clause 18: The variable light transmission device according to any one of clause 1 to clause 15, wherein the variable light transmission device comprises a microcell having a protrusion structure comprising from 1 to 5 wells.
Clause 19: The variable light transmission device according to any one of clause 1 to clause 15, wherein the variable light transmission device comprises a microcell having a protrusion structure comprising from 1 to 10 wells.
Clause 20: The variable light transmission device according to any one of clause 1 to clause 15, wherein the variable light transmission device comprises a microcell having a protrusion structure comprising from 1 to 15 wells.

### REFERENCE NUMBERS IS DRAWINGS

200, 300, 350 variable light transmission device according to the first embodiment; 500, 550, 560, 580, 590, 600, 650 variable light transmission device according to the second embodiment; 201 first light transmissive substrate; 202 first light transmissive electrode layer; 203 microcell layer; 204 plurality or microcells; 205 microcell opening; 206 sealing layer; 207 second light transmissive electrode layer; 208 second light transmissive substrate; 209 electrophoretic medium; 210 microcell bottom layer; 211 microcell bottom inside surface; 211a unexposed microcell bottom inside surface; 211b first exposed microcell bottom inside surface; 211c second exposed microcell bottom inside surface; 212 microcell wall; 213 microcell wall inside surface; 214 microcell wall upper surface; 215 channel; 216h channel height; 216wchannel base width; 217 protrusion structure; 217a solid part of protrusion structure; 217b well; 218 protrusion base; 219 protrusion structure solid part apex; 220 protrusion height; 221 protrusion side surface; 221a protrusion outside surface; 221b protrusion inside surface; 223 electrically charged pigment particles; 224 inner base perimeter of channel; 225 outer base perimeter of channel; 602 electric field.

The invention claimed is:

1. A variable light transmission device (200) comprising:
a first light transmissive electrode layer (202);
a second light transmissive electrode layer (207); and
a microcell layer (203), the microcell layer (203) being disposed between the first light transmissive electrode layer (202) and the second light transmissive electrode layer (207), the microcell layer (203) comprising a plurality of microcells (204) and a sealing layer (206), each microcell of the plurality of microcells (204) including an electrophoretic medium (209), the electrophoretic medium (209) comprising electrically charged pigment particles and a non-polar liquid, each microcell of the plurality of microcells (204) having a microcell opening (205), the sealing layer (206) spanning the microcell openings (205) of the plurality of microcells (204);
the sealing layer (206) of each microcell having an upper surface and a lower surface, the lower surface being in contact with the electrophoretic medium (209), the upper surface being in contact (i) with the first light transmissive electrode layer (202) or (ii) with an adhesive layer, the adhesive layer being disposed between the first light transmissive electrode layer (202) and the upper surface of the sealing layer (206);
each microcell of the plurality of microcells (204) comprising a microcell bottom layer (210), a protrusion structure (217), and a microcell wall (212), the microcell bottom layer (210) having a microcell bottom inside surface (211);
the protrusion structure (217) consisting of a protrusion structure solid part (217a), one or more wells (217b), the protrusion structure (217) having a protrusion base (218), an apex plane (229), and a protrusion height (220), the protrusion structure solid part (217a) having a protrusion structure solid part apex (219), a protrusion structure solid part side surface (221), and a protrusion structure solid part base (218a), the protrusion solid part apex (219) being a point or a set of points of the protrusion structure solid part (217a) having shorter distance from the microcell opening (205) than all other points of the protrusion structure solid part (217a), the apex plane (229) being a plane that is parallel to the plane of the microcell opening (205) and containing the protrusion structure solid part apex (219), the protrusion structure solid part side surface (221) being a surface of the protrusion structure solid part (217a) that is in contact with the electrophoretic medium (209) not including the protrusion structure solid part apex (219), the protrusion structure solid part base (218a) being a surface of the protrusion structure solid part (217a) that is in contact with the microcell bottom inside surface (211), the protrusion base (218) being a surface of the protrusion structure solid part and the surfaces of the one or more wells that are in contact with the microcell bottom layer (210), the protrusion height (220) being the distance between the apex plane (229) and the protrusion base (218), the protrusion structure (217) having a three-dimensional shape, the three-dimensional shape of the protrusion structure being a cylinder or a polygonal prism, the polygonal prism having a first base and a second base, the first base and the second base having each from 3 to 20 sides;
the one or more wells (217b) having a volume that is filled with electrophoretic medium (209), each of the one or more wells (217b) having a three-dimensional shape consisting of one geometric solid or a combination of two or more geometric solids, the three-dimensional shape of each of the one or more wells (217b) being defined by a space between (i) the apex plane (229), (ii) the protrusion structure solid part side surface (221), and (iii) the microcell bottom inside surface (211), the one geometric solid and each of the two or more geometric solids of the three-dimensional shape of each of the one or more wells being selected from the group consisting of a cone, a conical frustum, a cylinder, a conical frustum, a polygonal pyramid, a polygonal pyramidal frustum, and a polygonal prism, the cone having a base and an apex, the conical frustum having a large base and a small base, the cylinder having a first base and a second base, the polygonal pyramid having a base and an apex, the base of the polygonal pyramid being a polygon with 3-20 sides, the polygonal pyramidal frustum having a large base and a small base, the large base and the small base of the polygonal pyramidal frustum being a polygon with 3-20 sides, and the polygonal prism having a first base and a second base, the first base and the second base of the polygonal prism being a polygon with 3-20 sides;
the microcell wall (212) having a microcell inside wall surface (213) and a microcell wall upper surface (214), the microcell inside wall surface (213) being a surface of the microcell wall (212) of a microcell that is in contact with the electrophoretic medium (209), the microcell wall upper surface (214) being a surface of the microcell wall (212) of a microcell that is in contact with the sealing layer (206);
the variable light transmission device having a first outer surface (250) and a second outside surface (251), the first outside surface (250) being located on a side of the variable light transmission device that is near the first light transmissive electrode layer (202), and the second outside surface (251) being located on a side of the variable light transmission device that is near the second light transmissive electrode layer (207);
wherein application of a first electric field between the first light transmissive electrode layer (202) and the second light transmissive electrode layer (207) via a first waveform causes movement of the electrically charged pigment particles towards the one or more wells (217b), resulting in switching of the variable light transmission device to an open optical state;
wherein application of a second electric field between the first light transmissive electrode layer (202) and the second light transmissive electrode layer (207) via a second waveform causes a movement of the electrically charged pigment particles towards the first light transmissive electrode layer (202), wherein the closed optical state has lower percent transparency than the open optical state.

2. The variable light transmission device (200) of claim 1, wherein the three-dimensional shape of each of the one or more wells being selected from the group consisting of (a) a cone or a polygonal pyramid, the base of the cone or polygonal pyramid being in contact with the apex plane (229) and the apex of the cone or polygonal pyramid being in contact with the microcell bottom inside surface (211); (b) a cylinder, a conical frustum, a polygonal pyramidal frustum, or a polygonal prism, the first base of the cylinder, the large base of the conical frustum, the large base of the polygonal pyramidal frustum, or the first base of the pyramidal prism being in contact with the apex plane (229) and the second base of the cylinder, the small base of the conical frustum, the small base of the polygonal pyramidal frustum, and the second base of the polygonal prism being in contact with the microcell bottom inside surface; (c) a cylinder or a first conical frustum on a cone or a second conical frustum, the first base of the cylinder being in contact with the apex plane (229), the second base of the cylinder being in contact with the base of the cone or the large base of the conical frustum, and the apex of the cone or the small base of the conical frustum being in contact with the microcell bottom inside surface; (d) a polygonal prism or a first polygonal pyramidal frustum on a polygonal pyramid or a second polygonal pyramidal frustum, the first base of the polygonal prism or the large base of the first polygonal pyramidal frustum being in contact with the apex plane (229), the second base of the polygonal prism or the small base of the first polygonal pyramidal frustum being in contact with the base of the polygonal pyramid or the large base of the large polygonal pyramidal frustum, and the apex of the polygonal pyramid or the small base of the second polygonal pyramidal frustum being in contact with the microcell bottom inside surface, wherein the first and second bases of the polygonal prism, the large and small bases of the first polygonal pyramidal frustum, the base of the polygonal pyramid, and the large and small bases of the second polygonal pyramidal frustum have the same number of sides; (e) a first polygonal pyramidal frustum on a polygonal pyramid or a second polygonal pyramidal frustum or a polygonal prism, the large base of the first polygonal pyramid being in contact with the apex plane (229), the small base of the first polygonal pyramidal frustum being in contact with the base of the polygonal pyramid or the large base of the second polygonal pyramidal frustum or the first base of the polygonal prism, and the apex of the polygonal pyramid or the small base of the second polygonal pyramidal frustum being or the second base of the polygonal prism in contact with the microcell bottom inside surface, wherein the first and second bases of the first polygonal pyramidal frustum, the large and small bases of the second polygonal pyramidal frustum, the base of the polygonal pyramid, and the first and second bases of the polygonal prism have the same number of sides; (f) a first conical frustum on a cone or a second conical frustum or a cylinder, the large base of the first conical frustum being in contact with the apex plane (229), the small base of the first conical frustum being in contact with the base of the cone or large base of the second conical frustum or first base of the cylinder, and the apex of the cone or the small base of the second conical frustum or the second base of the cylinder being in contact with the microcell bottom inside surface; (g) a first cylinder on a first conical frustum on a cone or second conical frustum or second cylinder, the first base of the first cylinder being in contact with the apex plane (229), the second base of the first cylinder being in contact with the large base of the first conical frustum, the small base of the first conical frustum being in contact with the base of the cone or the large base of the second conical frustum or the first base of the second cylinder, and the apex of the cone or the small base of the second conical frustum or the second base of the second cylinder being in contact with the microcell bottom inside surface; (h) a first conical frustum on a cylinder or second conical frustum on a cone or third conical frustum, the large base of the first conical frustum being in contact with the apex plane (229), the small base of the first conical frustum being in contact with the first base of the cylinder or the large base of the second conical frustum, the second base of the cylinder or the small base of the second conical frustum being in contact with the base of the cone or the large base of the third conical frustum, and the apex of the cone or the small base of the third conical frustum being in contact with the microcell bottom inside surface; (i) a first conical frustum on a second conical frustum on a cone or third conical frustum or a cylinder, the large base of the first conical frustum being in contact with the apex plane (229), the small base of the first conical frustum being in contact with the large base of the second conical frustum, the small base of the second conical frustum being in contact with the base of the cone or the large base of the third conical frustum or the first base of the cylinder, and the apex of the cone or the small base of the third conical frustum or the second base of the cylinder being in contact with the microcell bottom inside surface; (j) a first polygonal pyramidal frustum on a pyramidal prism or second polygonal pyramidal frustum on a polygonal pyramid or third polygonal pyramidal frustum, the large base of the first polygonal pyramidal frustum being in contact with the apex plane (229), the small base of the first polygonal pyramidal frustum being in contact with the first base of the pyramidal prism or the large base of the second polygonal pyramidal frustum, the second base of the pyramidal prism or the small base of the second polygonal pyramidal frustum being in contact with the base of the polygonal pyramid or the large base of the third polygonal pyramidal frustum, and the apex of the pyramidal prism or the small base of the third polygonal pyramidal frustum being in contact with the microcell bottom inside surface, wherein the large and small bases of the first polygonal pyramidal frustum, the first and second bases of the pyramidal prism, the large and small bases of the second polygonal pyramidal frustum, the base of the polygonal pyramid, and the large and small bases of the third polygonal pyramidal frustum have the same number of sides; and (k) a first polygonal pyramidal frustum on a second polygonal pyramidal frustum on a polygonal pyramid or third polygonal pyramidal frustum or a polygonal prism, the large base of the first polygonal pyramidal frustum being in contact with the apex plane (229), the small base of the first polygonal pyramidal frustum being in contact with the large base of the second polygonal pyramidal frustum, the small base of the second polygonal pyramidal frustum being in contact with the base of the cone or the large base of the third conical frustum or the first base of the cylinder, and the apex of the polygonal pyramid or the small base of the third polygonal pyramidal frustum or the second base of the polygonal prism in contact with the microcell bottom inside surface, wherein the large and small bases of the first, second, and third polygonal pyramidal frustum, the first and second bases of the pyramidal prism, and the base of the polygonal pyramid have the same number of sides;

3. The variable light transmission device (200) of claim 1, wherein the three-dimensional shape of the protrusion structure (217) is selected from the group consisting of (a) a cylinder, the first base of the cylinder being the protrusion base (218) and the second base of the cylinder being in contact with the apex plane (229); (b) a polygonal prism, the first base of the polygonal prism being the protrusion base (218) and the second base of the polygonal prism being in contact with the apex plane (229), the first base and the second base having each from 3 to 20 sides; (c) a conical frustum, the large base of the conical frustum being the protrusion base (218) and the small base of the conical frustum being in contact with the apex plane (229); (d) a polygonal pyramidal frustum, the large base of the polygonal pyramidal frustum being the protrusion base (218), the small base of the polygonal pyramidal frustum being in contact with the apex plane (229), the large base and the small base of the polygonal pyramidal frustum each having the same number of sides, the number of sides being from 3 to 20 sides; (e) a first conical frustum on a cylinder or a second conical frustum, the first base of the cylinder or the large base of the second conical frustum being the protrusion base (218), the second base of the cylinder or the small base of the second conical frustum being in contact with the large base of the first conical frustum, the small base of the first conical frustum being in contact with the apex plane (229); and (f) a first polygonal pyramidal frustum on an polygonal prism or a second polygonal pyramidal frustum, the first base of the polygonal prism or the large base of the second pyramidal frustum being the protrusion base (218), the second base of the polygonal prism or the small base of the second pyramidal frustum being in contact with the large base of the first polygonal pyramidal frustum, and the small base of the first polygonal pyramidal frustum being in contact with the apex plane (229), wherein the large and small base of the first and second polygonal pyramidal frustum and the first and second bases of the pyramidal prism each have the same number of sides, the number of sides being from 3 to 20 sides.

4. The variable light transmission device of claim 1, wherein the microcell opening (205) of each microcell of the plurality of microcells (204) of the microcell layer (203) has a shape, the shape of the microcell opening (205) being selected from the group consisting of a circle, an ellipse, a square, a rectangle, and a polygon, the polygon having 5 to 12 sides.

5. The variable light transmission device of claim 1, wherein each microcell of the plurality of microcells (204) has a length of from 400 micrometers to 800 micrometers and a height of from 20 micrometers to 100 micrometers.

6. The variable light transmission device of claim 1, wherein the variable light transmission device comprises (i) an adhesive layer, the adhesive layer being disposed between the first light transmissive electrode layer (202) and the sealing layer (206), (ii) a second adhesive layer, the second adhesive layer being disposed between the microcell layer (203) and the second light transmissive electrode layer (207), or (iii) both the adhesive layer and the second adhesive layer.

7. The variable light transmission device of claim 1, wherein the variable light transmission device comprises a light blocking layer (230) disposed between the microcell wall upper surface (214) and the sealing layer (206), the light blocking layer (230) comprising light absorbing pigment.

8. The variable light transmission device of claim 7, wherein the light absorbing pigment of the light blocking layer (230) has black color.

9. The variable light transmission device of claim 1, wherein the electrically charged pigment particles (223) of the electrophoretic medium (209) are light absorbing.

10. The variable light transmission device of claim 1, wherein the second electric field causes a movement of the electrically charged pigment particles (223) towards the first light transmissive electrode layer (202) with a velocity, the velocity having a lateral component.

11. The variable light transmission device of claim 1, wherein the second waveform comprises at least one positive voltage and at least one negative voltage, the second waveform having a net positive or net negative impulse.

12. The variable light transmission device of claim 11, wherein the second waveform comprises an AC waveform, the AC waveform having a duty cycle of from 5% to 45%, or wherein the second waveform comprises a DC-offset waveform, which is formed by a superposition of a DC voltage component and an AC waveform.

13. The variable light transmission device of to claim 1, wherein the variable light transmission device comprises a microcell having a protrusion structure comprising 1 to 3 wells.

14. The variable light transmission device of claim 1, wherein the variable light transmission device comprises a microcell having a protrusion structure comprising from 1 to 5 wells.

15. The variable light transmission device of claim 1, wherein the variable light transmission device comprises a microcell having a protrusion structure comprising from 1 to 10 wells.

16. The variable light transmission device of claim 1, wherein each microcell comprises a protrusion structure, the protrusion structure including from 5 to 39 wells.

17. A variable light transmission device (300) comprising:
a first light transmissive electrode layer (202);
a second light transmissive electrode layer (207); and
a microcell layer (203), the microcell layer (203) being disposed between the first light transmissive electrode layer (202) and the second light transmissive electrode layer (207), the microcell layer (203) comprising a plurality of microcells (204) and a sealing layer (206), each microcell of the plurality of microcells (204) including an electrophoretic medium (209), the electrophoretic medium (209) comprising electrically charged pigment particles and a non-polar liquid, each microcell of the plurality of microcells (204) having a microcell opening (205), the sealing layer (206) spanning the microcell openings (205) of the plurality of microcells (204);
the sealing layer (206) of each microcell having an upper surface and a lower surface, the lower surface being in contact with the electrophoretic medium (209), the upper surface being in contact (i) with the first light transmissive electrode layer (202) or (ii) with an adhesive layer, the adhesive layer being disposed between the first light transmissive electrode layer (202) and the upper surface of the sealing layer (206);
each microcell of the plurality of microcells (204) comprising a microcell bottom layer (210), a channel (215), a protrusion structure (217), and a microcell wall (212), the microcell bottom layer (210) having a microcell bottom inside surface (211);
the microcell wall (212) having a microcell inside wall surface (213) and a microcell wall upper surface (214), the microcell inside wall surface (213) being a surface of the microcell wall (212) that is in contact with the electrophoretic medium (209), the microcell wall upper surface (214) being a surface of the microcell wall (212) that is in contact with the sealing layer (206);
the protrusion structure (217) consisting of a protrusion structure solid part (217a) and one or more wells (217b), the protrusion structure (217) having a protrusion base (218), an apex plane (229), and a protrusion height (220), the protrusion structure solid part (217a) having a protrusion structure solid part apex (219), a protrusion structure solid part side surface (221), and a protrusion structure solid part base (218a), the protrusion solid part apex (219) being a point or a set of points of the protrusion structure solid part (217a) having shorter distance from the microcell opening (205) than all other points of the protrusion structure solid part (217a), the apex plane (229) being a plane that is parallel to the plane of the microcell opening (205) and containing the protrusion structure solid part apex (219), the protrusion structure solid part side surface (221) being a surface of the protrusion structure solid part (217a) that is in contact with the electrophoretic medium (209) not including the protrusion structure solid part apex (219), the protrusion structure solid part base (218a) being a surface of the protrusion structure solid part (217a) that is in contact with the microcell bottom inside surface (211), the protrusion base (218) being a surface of the protrusion structure solid part and the surfaces of the one or more wells that are in contact with the microcell bottom layer (210), the protrusion height (220) being the distance between the apex plane (229) and the protrusion base (218);
the protrusion structure having a three-dimensional shape, the three-dimensional shape of the protrusion structure consisting of one geometric solid or a combination of two or more geometric solids, the one geometric solid and each of the two or more geometric solids of the three-dimensional shape of the protrusion structure being selected from the group consisting of a cylinder, a polygonal prism, a conical frustum, and a polygonal pyramidal frustum, the cylinder having a first base and a second base, the polygonal prism having a first base and a second base, the first base and the second base of the polygonal prism being a polygon with 3-20 sides, the conical frustum having a large base and a small base, the polygonal pyramidal frustum having a large base and a small base, the large base and the small base of the polygonal pyramidal frustum being a polygon with 3-20 sides;
the protrusion structure solid part side surface (221) consisting a protrusion structure solid part inside surface (221b) and a protrusion structure solid part outside surface (221a), the protrusion structure solid part inside surface (221b) being a part of the protrusion structure solid part side surface (221) that is in contact with the one or more wells (217b), the protrusion structure solid part outside surface (221a) being a part of the protrusion structure solid part side surface (221) that is not in contact with the one or more wells (217b);
the microcell bottom inside surface (211) consisting of an unexposed microcell bottom inside surface (211a), a first exposed microcell bottom inside surface (211b), and a second exposed bottom inside surface (211c), the unexposed microcell bottom inside surface (211a) being in contact with the protrusion structure solid part base (218a) and not in contact with the electrophoretic medium (209), the first exposed microcell bottom inside surface (211b) and the second exposed bottom inside surface (211c) being in contact with the electrophoretic medium (209), the first exposed microcell bottom inside surface (211c) being in contact with the channel (215), and the second exposed microcell bottom inside surface (211b) being in contact with the one or more wells (217b);
the channel (215) having a channel height (216h), an inner base perimeter (225), and an outer base perimeter (226), the channel (215) having a volume that is filled with electrophoretic medium (209), the channel being a three-dimensional shape that is defined by the protrusion structure solid part outside surface (221a), the first exposed microcell bottom inside surface (211b), the microcell inside wall surface (213), and a plane that is parallel to the first exposed microcell bottom inside surface (211b), the plane having a distance from first exposed microcell bottom inside surface (211b) equal to the channel height (216h), the channel height (216h) being 50% of the protrusion height (220), the inner base perimeter (225) being an intersection of the microcell wall (212) and the first exposed microcell bottom inside surface (211b), the outer base perimeter (226) being an intersection of the protrusion structure solid part outside surface (221a) and the first exposed microcell bottom inside surface (211b);
each of the one or more wells (217b) having a volume that is filled with electrophoretic medium (209), each of the one or more wells (217b) having a three-dimensional shape consisting of one geometric solid or a combination of two or more geometric solids, the three-dimensional shape of each of the one or more wells (217b) being defined by a space between (i) the apex plane (229), (ii) the protrusion structure solid part inside surface (221b), and (iii) the second exposed microcell bottom inside surface (211c), the one geometric solid and each of the two or more geometric solids of the three-dimensional shape of each of the one or more wells being selected from the group consisting of a cone, a conical frustum, a cylinder, a conical frustum, a polygonal pyramid, a polygonal pyramidal frustum, and a polygonal prism, the cone having a base and an apex, the conical frustum having a large base and a small base, the cylinder having a first base and a second base, the polygonal pyramid having a base and an apex, the base of the polygonal pyramid being a polygon with 3-20 sides, the polygonal pyramidal frustum having a large base and a small base, the large base and the small base of the polygonal pyramidal frustum being a polygon with 3-20 sides, and the polygonal prism having a first base and a second base, the first base and the second base of the polygonal prism being a polygon with 3-20 sides;
the variable light transmission device having a first outer surface (250) and a second outside surface (251), the first outside surface (250) being located on a side of the variable light transmission device that is near the first light transmissive electrode layer (202), and the second outside surface (251) being located on a side of the variable light transmission device that is near the second light transmissive electrode layer (207);
wherein application of a first electric field between the first light transmissive electrode layer (202) and the second light transmissive electrode layer (207) via a first waveform causes movement of the electrically charged pigment particles towards the one or more wells (217b) and the channel, resulting in switching of the variable light transmission device to an open optical state;
wherein application of a second electric field between the first light transmissive electrode layer (202) and the second light transmissive electrode layer (207) via a second waveform causes a movement of the electrically charged pigment particles towards the first light transmissive electrode layer (202), wherein the closed optical state has lower percent transparency than the open optical state.

18. The variable light transmission device of claim 17, wherein the channel (215) has a width of from 10 micrometers to 30 micrometers.

19. The variable light transmission device of claim 17, wherein the variable light transmission device comprises a microcell the inside wall surface (213) and the first exposed microcell bottom surface (211b) of which form an angle (φ) of from 90 to 120 degrees.

20. The variable light transmission device of claim 17, wherein the variable light transmission device comprises a microcell having a protrusion structure comprising from 1 to 10 wells.
